(19) United States
(12) Patent Application Publication
(10) Pub. No.: US 2024/0311924 A1
(43) Pub. Date: Sep. 19, 2024

(54) ASSESSING DAMAGES ON VEHICLES

(71) Applicant: Vehicle Service Group, LLC, Downers Grove, IL (US)

(72) Inventors: Bodhayan Dev, Sturbridge, MA (US); Michael Johannes, Danvers, MA (US); Sreedhar Patnala, Holliston, MA (US); Geert Willems, Hechtel-Eksel (BE)

(21) Appl. No.: 18/598,263

(22) Filed: Mar. 7, 2024

Related U.S. Application Data
(60) Provisional application No. 63/452,361, filed on Mar. 15, 2023.

(51) Int. Cl. G06Q 40/08; G06T 7/00

(52) U.S. Cl. CPC G06Q 40/08; G06T 7/001; G06T 2207/20081; G06T 2207/20084; G06T 2207/30252

(57) ABSTRACT

Methods, devices, apparatus, systems and computer-readable storage media for assessing damages on vehicles are provided. In one aspect, a computer-implemented method includes: determining present damage data of at least one section of a vehicle based on an image of the at least one section of the vehicle using at least one machine learning model, comparing the present damage data of the at least one section of the vehicle to historical damage data of the at least one section of the vehicle to generate a comparison result, and determining whether there is a fraud event based on the comparison result. The present damage data includes information of a plurality of hail damage areas on the at least one section of the vehicle.

### CROSS-REFERENCE TO RELATED APPLICATION

This application claims priority under 35 USC § 119(e) to U.S. Provisional Patent Application Ser. No. 63/452,361, entitled “ASSESSING DAMAGES ON VEHICLES” and filed on Mar. 15, 2023, the entire content of which is hereby incorporated by reference.

### BACKGROUND

Repairing damage to bodywork is a common task undertaken by repair shops and garages world-wide. In the mid-western United States alone, approximately 20,000 insurance claims relating to hail damage are filed every year. Repair shops therefore need to assess damages associated with hailstorms and other body-work damages in an efficient manner. Damage counts per panel of vehicles are normally obtained manually to generate repair estimates, which is time consuming, labor tedious, and unreliable with low accuracy. Also, fraudulent acts can occur when customers file insurance claims multiple times for same hail damages on their vehicles.

### SUMMARY

The present disclosure describes methods, systems and techniques for assessing damages (e.g., hail dents) on vehicles, e.g., for fraud detection and/or hail dent adjustment.

One aspect of the present disclosure features a computer-implemented method including: determining present damage data of at least one section of a vehicle based on an image of the at least one section of the vehicle using at least one machine learning (ML) model, the present damage data including information of a plurality of hail damage areas on the at least one section of the vehicle; comparing the present damage data of the at least one section of the vehicle to historical damage data of the at least one section of the vehicle to generate a comparison result; and determining whether there is a fraud event based on the comparison result.

In some embodiments, determining whether there is a fraud event based on the comparison result includes: determining whether a similarity between the present damage data and the historical damage data is greater than a predetermined threshold based on the comparison result.

In some embodiments, the computer-implemented method further includes: in response to determining that the similarity between the present damage data and the historical damage data is greater than the predetermined threshold based on the comparison result, determining that there is a fraud event for the present damage data of the at least one section of the vehicle. In some embodiments, the computer-implemented method further includes at least one of: setting a fraud detection flag for the present damage data of the at least one section of the vehicle, or generating a notification indicating the fraud event for the present damage data of the at least one section of the vehicle.

In some embodiments, the computer-implemented method further includes: in response to determining that the similarity between the present damage data and the historical damage data is no greater than the predetermined threshold based on the comparison result, determining that there is no fraud event for the present damage data of the at least one section of the vehicle. In some embodiments, the computer-implemented method further includes at least one of: generating a notification indicating there is no fraud event for the present damage data of the at least one section of the vehicle, or generating a damage assessment report based on the present damage data of the at least one section of the vehicle.

In some embodiments, determining whether the similarity between the present damage data and the historical damage data is greater than the predetermined threshold based on the comparison result includes at least one of: determining whether a ratio indicating a difference between a present number of hail damage areas on the at least one section of the vehicle and a historical number of hail damage areas in the at least one section of the vehicle is smaller than a first threshold, determining whether a similarity between present flow trajectories around present hail damage areas on the at least one section of the vehicle and historical flow trajectories around historical hail damage areas on the at least one section of the vehicle is greater than a second threshold, or determining whether a similarity between one or more present image portions of the image of the at least one section of the vehicle and one or more corresponding image portions of a historical image of the at least one section of the vehicle is greater than a third threshold.

In some embodiments, the present damage data of the at least one section of the vehicle includes a respective number of hail damage areas for each of one or more panels presented in the at least one section of the vehicle. Determining whether the similarity between the present damage data and the historical damage data is greater than the predetermined threshold based on the comparison result includes: determining whether a ratio indicating a difference between a present number of hail damage areas in one of the one or more panels and a historical number of hail damage areas in the one of the one or more panels is smaller than a predetermined threshold.

In some embodiments, the computer-implemented method further includes: for each of the one or more panels, classifying one or more identified hail damage areas correlated with the panel according to one or more category types for the one or more identified hail damage areas; and for each of the one or more category types, counting a respective number of identified hail damage areas that are correlated with the panel and have a same category type. Determining whether the similarity between the present damage data and the historical damage data is greater than the predetermined threshold based on the comparison result includes at least one of: for each of the one or more panels and for each of the one or more category types, determining whether a ratio indicating a difference between a present number of identified hail damage areas with the category type and a historical number of identified hail damage areas with the category type is smaller than a second predetermined threshold, or for each of the one or more panels, determining an average of one or more ratios for the one or more category types is smaller than a third predetermined threshold.

In some embodiments, determining whether the similarity between the present damage data and the historical damage data is greater than the predetermined threshold based on the comparison result includes: obtaining each of a plurality of sub-regions of the image of the at least one section of the vehicle; generating a present flow trajectory image of the sub-region, the present flow trajectory image representing flow trajectories around one or more hail damage areas on the sub-region of the image of the at least one section of the vehicle; determining a similarity score for the sub-region by comparing the present flow trajectory image of the sub-region of the image of the at least one section of the vehicle with a historical flow trajectory image of a corresponding sub-region of a historical image of the at least one section of the vehicle to obtain a similarity score for the sub-region; and determining the similarity between the present damage data and the historical damage data based on the similarity score for the sub-region.

In some embodiments, determining the similarity between the present damage data and the historical damage data based on the similarity score for the sub-region includes: determining the similarity based on an average similarity score of similarity scores for the plurality of sub-regions of the image of the at least one section of the vehicle.

In some embodiments, obtaining each of the plurality of sub-regions of the image of the at least one section of the vehicle includes: moving a sliding window on the image to sequentially extract the plurality of sub-regions. In some embodiments, moving the sliding window on the image includes: moving the sliding window along horizontal and vertical directions to ensure a full coverage of a region of interest in the image of the at least one section of the vehicle. In some embodiments, moving the sliding window on the image includes: updating a size of the sliding window based on a size of a bounding box of the region of interest. In some embodiments, there is an overlap between adjacent sub-regions among the plurality of sub-regions of the image.

In some embodiments, generating the present flow trajectory image of the sub-region includes: using at least one particle flow simulation algorithm to approximate a flow field around each of the one or more hail damage areas on the sub-region, the at least one particle flow simulation algorithm including a particle image velocimetry (PIV) algorithm. In some embodiments, determining the similarity score for the sub-region includes: computing the similarity score between the present flow trajectory image and the historical flow trajectory image using one or more image similarity algorithms including Frechet Inception Distance (FID), Mean Squared Error (MSE), and Structural Similarity Indices (SSIM), and Cosine Similarity.

In some embodiments, determining whether the similarity between the present damage data and the historical damage data is greater than the predetermined threshold based on the comparison result includes: obtaining a plurality of portions of the image of the at least one section of the vehicle; for each portion of the plurality of portions, comparing the portion of the image of the at least one section of the vehicle with a corresponding portion of a historical image of the at least one section of the vehicle to obtain a similarity score for the portion; and determining the similarity between the present damage data and the historical damage data based on the similarity score for each portion of the plurality of portions.

In some embodiments, obtaining each of the plurality of portions of the image of the at least one section of the vehicle includes: defining a grid on the image of the at least one section of the vehicle, where there is no overlap between adjacent portions of the plurality of portions of the image.

In some embodiments, determining the similarity between the present damage data and the historical damage data based on the similarity score for the portion includes: determining the similarity based on an average similarity score of similarity scores for the plurality of portions of the image of the at least one section of the vehicle.

In some embodiments, determining the similarity score for the portion includes: computing the similarity score between the portion of the image and the corresponding portion of the historical image using one or more image similarity algorithms including Frechet Inception Distance (FID), Mean Squared Error (MSE), Structural Similarity Indices (SSIM), and cosine similarity.

In some embodiments, the image of the at least one section of the vehicle includes a processed image with a respective bounding box enclosing each of the plurality of hail damage areas on the at least one section of the vehicle.

In some embodiments, determining the present damage data of the at least one section of the vehicle based on the image of the at least one section of the vehicle using the at least one machine learning (ML) model includes at least one of: identifying the plurality of hail damage areas present on the at least one section of the vehicle in the image using a first model that has been trained; identify one or more panels of the vehicle that are present in the at least one section of the vehicle in the image using a second model that has been trained; or generating the present damage data by correlating the plurality of hail damage areas and the one or more panels to determine, for each of the one or more panels of the vehicle, one or more respective hail damage areas that are present on the panel.

In some embodiments, the first model includes at least one of: You Only Look Once (YOLO), single-shot detector (SSD), Faster Region-based Convolutional Neural Network (Faster R-CNN), or a computer vision algorithm, and the second model includes at least one of: masked R-CNN, thresholding segmentation, edge-Based segmentation, region-based segmentation, watershed segmentation, or clustering-based segmentation.

In some embodiments, the computer-implemented method further includes: obtaining the image of the at least one section of the vehicle by at least one of: scanning the at least one section of the vehicle at a scanning position using a hybrid three-dimensional (3D) optical scanning system or a camera of a mobile device, receiving the image from a remote communication device configured to capture images of the vehicle, generating the image based on at least one frame of a video stream for the at least one section of the vehicle, generating the image based on multiple sectional images of the vehicle, each of the multiple sectional images being associated with a different corresponding section of the vehicle, or processing an initial image of the at least one section of the vehicle to reduce surface glare of the vehicle in the initial image.

In some embodiments, the computer-implemented method further includes: obtaining the historical damage data of the at least one section of the vehicle from a repository based on information of the at least one section of the vehicle.

In some embodiments, the computer-implemented method further includes: checking whether historical data of the vehicle is available in a repository based on identification information of the vehicle; and if the historical data of the vehicle is available in the repository, proceeding to perform fraud detection on the image of the at least one section of the vehicle, or if there is no historical data of the vehicle in the repository, proceeding to generate a damage assessment report for the vehicle, without fraud detection for the vehicle. The identification information of the vehicle can include vehicle identification number (VIN) of the vehicle.

In some embodiments, determining the present damage data of the at least one section of the vehicle based on the image of the at least one section of the vehicle includes: adjusting a number of hail damage areas on the at least one section of the vehicle. In some embodiments, adjusting the number of hail damage areas on the at least one section of the vehicle includes: adjusting the number of hail damage areas on the at least one section of the vehicle based on one or more variables that include a color of the at least one section of the vehicle, ambient lighting when scanning the at least one section of the vehicle for the image, or a preference of an operator.

In some embodiments, adjusting the number of hail damage areas on the at least one section of the vehicle includes: adjusting a probability threshold by receiving an input on a user interface element for adjusting the probability threshold in a graphical user interface (GUI).

In some embodiments, adjusting the number of hail damage areas on the at least one section of the vehicle includes: automatically adjusting a probability threshold by adjusting the probability threshold based on one or more predetermined settings, where the probability threshold is determined based on the one or more predetermined settings by a machine learning model that has been trained based on historical information including at least one of geographical regions, vehicle types, colors, or hail damage densities per panel. In some embodiments, adjusting the number of hail damage areas on the at least one section of the vehicle includes: presenting the probability threshold to an operator; and adjusting the probability threshold based on an input of the operator.

In some embodiments, adjusting the number of hail damage areas on the at least one section of the vehicle includes at least one of: adjusting a respective number of hail damage areas on each of one or more panels in the at least one section of the vehicle, or adjusting a total number of hail damage areas on the one or more panels in the at least one section of the vehicle.

In some embodiments, determining the present damage data of the at least one section of the vehicle based on the image of the at least one section of the vehicle includes: filtering out one or more particular damage areas on the at least one section of the vehicle, each of the one or more particular damage areas being different from a hail damage area. In some embodiments, filtering out the one or more particular damage areas on the at least one section of the vehicle includes: filtering out the one or more particular damage areas using a machine learning model that has been trained to detect or classify particular damage areas. In some embodiments, the one or more particular damage areas include one or more damage or pinch point signatures caused by metal deformation at one or more particular locations.

Another aspect of the present disclosure features a computer-implemented method including: obtaining an image of at least one section of a vehicle; determining hail damage data of the at least one section of the vehicle based on the image of the at least one section of the vehicle using at least one machine learning (ML) model, the hail damage data including information of hail damage areas on the at least one section of the vehicle; adjusting the hail damage data of the at least one section of the vehicle by adjusting a number of the hail damage areas on the at least one section of the vehicle; and generating an output about hail damage assessment information of the at least one section of the vehicle based on the adjusted hail damage data.

In some embodiments, adjusting the hail damage data of the at least one section of the vehicle includes: adjusting the hail damage data of the at least one section of the vehicle based on one or more variables, where the one or more variables include a color of the at least one section of the vehicle, ambient lighting when scanning the at least one section of the vehicle for the image, or a preference of an operator.

In some embodiments, adjusting the number of the hail damage areas on the at least one section of the vehicle includes: adjusting a probability threshold by receiving an input on a user interface element for adjusting the probability threshold in a graphical user interface (GUI).

In some embodiments, the computer-implemented method further includes: presenting, in the GUI, the user interface element as an adjustable slider, an image of the vehicle showing a plurality of panels of the vehicle in different colors, and names of the plurality of panels with corresponding numbers of hail damage areas on the plurality of panels, where the corresponding number of hail damage areas on the plurality of panels are changeable with the probability threshold by the adjustable slider.

In some embodiments, adjusting the number of the hail damage areas on the at least one section of the vehicle includes: automatically adjusting a probability threshold by adjusting the probability threshold based on one or more predetermined settings, where the probability threshold is determined based on the one or more predetermined settings by a machine learning model that has been trained based on historical information including at least one of geographical regions, vehicle types, colors, or hail damage densities per panel.

In some embodiments, adjusting the number of the hail damage areas on the at least one section of the vehicle includes: presenting the probability threshold to an operator; and adjusting the probability threshold based on an input of the operator.

In some embodiments, adjusting the number of the hail damage areas on the at least one section of the vehicle includes: adjusting a respective number of hail damage areas on each of one or more panels in the at least one section of the vehicle, or adjusting a total number of hail damage areas on the one or more panels in the at least one section of the vehicle.

In some embodiments, determining the hail damage data of the at least one section of the vehicle based on the image of the at least one section of the vehicle includes: filtering out one or more particular damage areas on the at least one section of the vehicle, each of the one or more particular damage areas being different from a hail damage area.

In some embodiments, filtering out the one or more particular damage areas on the at least one section of the vehicle includes: filtering out the one or more particular damage areas using a machine learning model that has been trained to detect or classify particular damage areas. In some embodiments, the one or more particular damage areas include one or more damage or pinch point signatures caused by metal deformation at one or more particular locations.

In some embodiments, determining the hail damage data of the at least one section of the vehicle based on the image of the at least one section of the vehicle using the at least one machine learning (ML) model includes at least one of: identifying the plurality of hail damage areas present on the at least one section of the vehicle in the image using a first model that has been trained; identify one or more panels of the vehicle that are present in the at least one section of the vehicle in the image using a second model that has been trained; or generating the hail damage data by correlating the plurality of hail damage areas and the one or more panels to determine, for each of the one or more panels of the vehicle, one or more respective hail damage areas that are present on the panel.

In some embodiments, the first model includes at least one of: You Only Look Once (YOLO), single-shot detector (SSD), Faster Region-based Convolutional Neural Network (Faster R-CNN), or a computer vision algorithm, and the second model includes at least one of: masked R-CNN, thresholding segmentation, edge-Based segmentation, region-based segmentation, watershed segmentation, or clustering-based segmentation.

In some embodiments, the computer-implemented method further includes: determining whether there is a fraud event based on the adjusted hail damage data, and generating the output about the hail damage assessment information of the at least one section of the vehicle based on the adjusted hail damage data includes: in response to determining that there is a fraud event, setting a fraud detection flag or generating a notification indicating the fraud event, or in response to determining that there is no fraud event, generating a damage assessment report based on the adjusted hail damage data.

Another aspect of the present disclosure features a computer-implemented method including: obtaining an image of at least one section of a vehicle; determining hail damage data of the at least one section of the vehicle based on the image of the at least one section of the vehicle using at least one machine learning (ML) model, the hail damage data including information of hail damage areas on the at least one section of the vehicle; and generating an output about hail damage assessment information of the at least one section of the vehicle based on the hail damage data of the at least one section of the vehicle. Determining the hail damage data of the at least one section of the vehicle includes: filtering out one or more particular damage areas on the at least one section of the vehicle, each of the one or more particular damage areas being different from a hail damage area.

In some embodiments, the one or more particular damage areas include one or more damage or pinch point signatures caused by metal deformation at one or more particular locations.

In some embodiments, filtering out the one or more particular damage areas on the at least one section of the vehicle includes: filtering out the one or more particular damage areas using a machine learning model that has been trained to detect or classify particular damage areas.

In some embodiments, determining the hail damage data of the at least one section of the vehicle based on the image of the at least one section of the vehicle using the at least one machine learning (ML) model includes at least one of: identifying the plurality of hail damage areas present on the at least one section of the vehicle in the image using a first model that has been trained; identify one or more panels of the vehicle that are present in the at least one section of the vehicle in the image using a second model that has been trained; or generating the hail damage data by correlating the plurality of hail damage areas and the one or more panels to determine, for each of the one or more panels of the vehicle, one or more respective hail damage areas that are present on the panel.

In some embodiments, the first model includes at least one of: You Only Look Once (YOLO), single-shot detector (SSD), Faster Region-based Convolutional Neural Network (Faster R-CNN), or a computer vision algorithm, and the second model includes at least one of: masked R-CNN, thresholding segmentation, edge-Based segmentation, region-based segmentation, watershed segmentation, or clustering-based segmentation.

In some embodiments, the computer-implemented method further includes: determining whether there is a fraud event based on the adjusted hail damage data, and generating the output about the hail damage assessment information of the at least one section of the vehicle based on the adjusted hail damage data includes: in response to determining that there is a fraud event, setting a fraud detection flag or generating a notification indicating the fraud event, or in response to determining that there is no fraud event, generating a damage assessment report based on the adjusted hail damage data.

Another aspect of the present disclosure features an apparatus including: at least one processor; and one or more memories coupled to the at least one processor and storing programming instructions for execution by the at least one processor to perform any of the computer-implemented methods as described above.

Another aspect of the present disclosure features a non-transitory computer readable storage medium coupled to at least one processor and having machine-executable instructions stored thereon that, when executed by the at least one processor, cause the at least one processor to perform any of the computer-implemented methods as described above.

Implementations of the above techniques include methods, systems, computer program products and computer-readable media. In one example, a method can be performed one or more processors and the method can include the above-described actions performed by the one or more processors. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described actions.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a schematic diagram of an example environment for assessing damages on vehicles.

FIG. 2 is a schematic diagram of an example of dent detection.

FIG. 3 is a schematic diagram of an example of panel identification.

FIG. 4 is a schematic diagram of an example system for reducing noise in images for damage detection.

FIG. 5A shows a flow diagram of an example process for damage density determination.

FIG. 5B is a flow diagram of an example process for generating images in a standard format for hail damage analysis.

FIG. 6 is a flow chart of an example process for assessing damages on vehicles.

FIG. 7A shows an example panel damage density estimate.

FIG. 7B shows an example table in a damage assessment report.

FIG. 8A is a flow chart of an example process for fraud detection.

FIG. 8B shows an example fraud detection with hail Strom and particle trajectory tracking.

FIG. 8C shows another example fraud detection with hail density pattern matching.

FIG. 9 is a screen shot of an example graphical user interface (GUI) of an application for assessing damages on a vehicle.

FIGS. 10A-10B are example images showing damage signatures other than hail damage.

FIG. 10C is a flow chart of an example process for managing damage signatures on a vehicle.

FIG. 10D shows a training dataset for identifying damage signature.

FIG. 10E shows detected damage signatures in an image.

FIG. 11 is a flow chart of an example process for assessing damages on vehicles for fraud detection.

FIG. 12 is a flow chart of an example process for assessing damages on vehicles with adjusting hail damage data.

FIG. 13 is a flow chart of an example process for assessing damages on vehicles with filtering out damage signatures.

Like reference numbers and designations in the various drawings indicate like elements.

### DETAILED DESCRIPTION

Damages on vehicles include major damages (e.g., crash damages) and minor damages (e.g., hail dents due to hailstorms). A minor damage area is an area in which a surface profile of a vehicle has been deformed (e.g., plastically) from its original profile when the vehicle was first assembled. The minor damage area can be an area surrounded by non-damaged surface(s). The minor damage area can be less than about an inch across. In general, the term “damage area” in the present disclosure refers to a minor damage area, such as hail dents.

Damage detection techniques can rely on a combination of classical computer vision techniques. In some examples, a hybrid three-dimensional (3D) optical scanning system can combine methodologies of active stereo 3D reconstruction and deflectometry to provide accurate 3D surface measurements of an object under inspection. In some examples, a constellation scanner can use stereo-pair imaging techniques in conjunction with advanced deep-learning models to estimate hail dent counts per panel and to finally generate an insurance claim-estimate report. In some examples, a user (e.g., a paintless dent repair (PDR) technician) can mark (e.g., scribe or draw) specific shapes on each vehicle panel to detect dents under hail lighting conditions. The user can use a mobile application deployed in a mobile device to capture an image of at least one section of the vehicle and generate hail damage data using at least one machine learning model (e.g., glare reduction model, dente detection model, and/or panel detection model) and/or a damage assessment report. The models can be executed in the mobile device and/or a remote server in communication with the mobile device.

In some cases, customers (e.g., vehicle owners) may attempt to bend rules by getting insurance claims funded multiple times. The customers may not fix hail dents on their vehicles after filing a first insurance claim, and may wait for a period of time for another hail-storm season to hit and then come back for reclaiming the insurance from prior storms. These fraudulent acts may be frequent.

Implementations of the present disclosure provide techniques for determining fraudulent acts, e.g., filing multiple insurance claims on same hail damages. In some implementations, a scanning system or a mobile device obtains an image of at least one section of a vehicle (e.g., by scanning or capturing). An application (e.g., at least one software application) can be installed in the scanning system, the mobile device, and/or a server in communication with the scanning system and/or the mobile device. The application can use image acquisition/pre-processing techniques in conjunction with one or more machine-learning (or deep-learning) models (e.g., glare reduction model, dent detection model, and/or panel detection model) to estimate hail dent counts per panel and finally generate an insurance claim-estimate report. Each scan information (e.g., scanned images) can be backed up onto the server, e.g., a cloud platform, for collecting customer data and associated vehicle damage data.

In some embodiments, the application is further configured to perform fraud detection and/or flagging with one or more mechanisms, e.g., by determining a similarity between historical damage data and new damage data on vehicles. The one or more mechanisms can include: checking similar dent counts, checking hail Strom and particle trajectory tracking, and/or checking hail density pattern matching within refined grids. If flag notifications are received from any one of the mechanisms or corresponding workflows, the application can notify an operator. The application can be modified for manual review, depending on operator/user requirements.

In some examples, the application is configured to check if a number of dents per panel from new scan are in a proximity of historical scan for each panel of a vehicle, and raise flag for review if the numbers are close enough within a pre-defined tolerance range/threshold. In some examples, the application is configured to generate particle flow trajectories around hail dents using physics-inspired techniques, compare/compute image similarity scores on historical and new flow trajectories, and raise flag for review if net/average similarity scores are high per scan. In some examples, the application is configured to define a refined grid on each scanned image, compare/compute image similarity scores on historical and new images for each grid in the scanned image, compute an average similarity score for each grid-image pairs from new-historical scans, and raise flag for review if average similarity scores are high per scan.

In some embodiments, the application is configured to fine-tune the total dent count of hail dents on the vehicles or hail dent count per panel of the vehicles. The application can have sensitivity adjustment features according to user preferences or variables of a particular shop and/or scan. In some examples, the dent count can be adjusted based on variables that might include: i) color of the vehicle (dents can be harder to distinguish on darker vehicles); ii) ambient lighting in shop (which changes ability to distinguish whether a dent is present or not); and/or iii) human preference for what should be considered a dent/damage.

The application can be configured to adjust the total dent count or individual dent counts for panels by using a probability threshold. The application can use the probability threshold to clean the damage data according to user preferences. The probability threshold can be fine-tuned manually, e.g., a slidable/tunable dial integrated in a user interface (UI), or automatically, e.g., by performing a function based on historical or other customer data points. In addition, the application can be equipped advanced ML models to filter out prior damage/pinch points (caused by metal deformation not related to hailstorms/dents) automatically from final dents to further improve dent counts per panel.

The techniques described in the present disclosure produce several technical effects and/or advantages. For example, compared to purely manual count of dents in vehicles, the techniques can automatically detect dents and/or shapes in different panels using a machine learning trained model, which are more accurate, fast, reliable, and with less labor, particularly when there are large numbers of dents (e.g., 100s or 1000s) and it would be impossible for a manual count to be accurate. The machine learning trained model can also provide a more accurate count of different dent sizes and/or shape types, since a user cannot be able to accurately tell one size or one shape from another by just looking at it. Accordingly, the final cost estimate can also be more accurate using the techniques. In some embodiments, by automatically detecting dents per panel and/or determining a similarity between historical damage data and new damage data, the techniques enable to determine whether there is any fraud event and raise flag or send alert/notification for manual attention/review, which can greatly increase efficiency, reliability, and accuracy in fraud detection to thereby protect the interest of insurance companies or any other related entities. Further, the techniques enable users (e.g., PDR technicians or vehicle evaluation/repair shop operators) to fine-tune dent counts according to their own preferences or particular variables. The techniques also enable to filter out damage signatures not related to hailstorms/dents and improve accuracy of hail dent counts per panel for more accurate fraud detection, damage assessment, and/or final cost estimate. Besides hailstorms/dents, the techniques implemented herein can be also applied for any other suitable types of damages on vehicles. Besides vehicles, the techniques implemented herein can be also applied for any other suitable types of devices.

### Example Systems and Devices

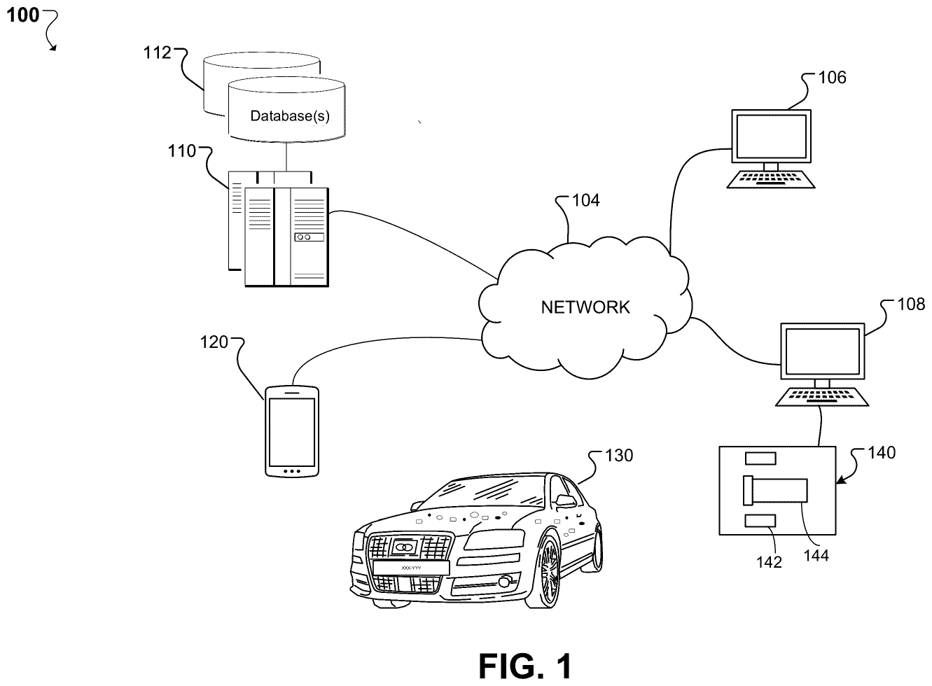

FIG. 1 is a schematic diagram of an example environment 100 for assessing damages on vehicles. The environment 100 enables users (e.g., PDR technicians or vehicle evaluation/repair shop operators) to assess damages on vehicles and to generate damage assessment reports for repair estimates or insurance claims in a simple, fast, and accurate way. The environment 100 also enables the users to adjust damage data on the vehicles per the users' preferences or variables for more accurate and/or reliable damage assessment. The environment 100 also enables to detect and flag any fraud events, e.g., customers such as vehicle owners filing multiple insurance claims on same damage areas (e.g., hail dents).

In some embodiments, the environment 100 involves a service computing system 110 (e.g., a cloud computing platform) and one or more databases 112 that can be associated with a service provider, a network 104, a computing device 106 associated with a business entity (e.g., an insurance company), a computing device 108 associated with a vehicle evaluation and/or repair shop having a scanning system 140, and/or a portable computing device (e.g., a mobile device) 120. The computing devices and systems 106, 108, 110, 120 can communicate with each other over the network 104. The environment 100 enables to assess damages on a vehicle 130, e.g., due to hailstorm conditions. The vehicle 130 can be any suitable type of vehicle, e.g., motorcycle, sedan, SUV, car, or truck. Other embodiments are also possible, including embodiments with more or fewer parties. For example, the environment 100 can include one or more users with associated computing devices, one or more insurance companies with associated computing devices, one or more vehicle evaluation/repair shops with associated computing devices, and/or one or more image capturing devices in communication with the network 104.

The network 104 can include a large computer network, such as a local area network (LAN), a wide area network (WAN), the Internet, a cellular network, or a combination thereof connecting any number of mobile computing devices, fixed computing devices and server systems. The service computing system 110 can include one or more computing devices and one or more machine-readable repositories, or databases. In some embodiments, the service computing system 110 can be a cloud computing platform that includes one or more server computers in a local or distributed network each having one or more processing cores. The service computing system 110 can be implemented in a parallel processing or peer-to-peer infrastructure or on a single device with one or more processors. The computing device 106, 108 can be any type of devices, systems, or servers, e.g., a desktop computer, a mobile device, a smart mobile phone, a tablet computing device, a notebook, or a portable communication device. The portable computing device 120 can include any appropriate type of device such as a tablet computing device, a camera, a handheld computer, a portable device, a mobile device, a personal digital assistant (PDA), a cellular telephone, a network appliance, a smart mobile phone, an enhanced general packet radio service (EGPRS) mobile phone, or any appropriate combination of any two or more of these data processing devices or other data processing devices.

In some embodiments, the scanning system 140 is controlled by the computing device 108, e.g., by a vehicle evaluation/repair shop operator, to scan the vehicle 130, e.g., to obtain images of a plurality of sections of the vehicle 130, where each section can include one or more panels. At each scanning position, the scanning system 140 can acquire a corresponding scanning image of a section of the vehicle 130. In some embodiments, the computing device 108 is integrated with the scanning system 140, and the user has another computing device in communication with the computing device 108 to receive scanned images transmitted from the computing device 108, process the scanned images, communicate with the service computing system 110 through the network 104, and/or performing fraud detection and damage assessment report.

In some embodiments, the scanning system 140 includes a hybrid 3D optical scanning system combining methodologies of active stereo 3D reconstruction and deflectometry to provide accurate 3D surface measurement of the vehicle 130. The scanning system 140 can include a calibrated digital camera stereo pair 142 and one or more digital projectors 144 for active stereo 3D reconstruction and deflectometry. In some embodiments, an example scanning system can be configured and performed as described in an International Application PCT/US2017/000043, entitled “HYBRID 3D OPTICAL SCANNING SYSTEM” and filed on Jul. 27, 2017, which is commonly-owned and fully incorporated herein by reference.

In some embodiments, the scanning system 140 includes a mobile scanning booth assembled in an open-ended tunnel-like rig and a plurality of scanner modules. The mobile scanning booth can have a plurality of reflective panels positioned along opposite sides and across the roof of the booth to serve as deflection screens. The plurality of scanner modules are mounted in fixed positions about opposite ends of the booth and positioned to face the interior of the booth. Wheels can provide controlled locomotion/movement of the scanning mobile booth over the vehicle 130 that is stationary. Each of the scanner modules can use a combined hybrid methodology of active stereo 3D reconstruction and deflectometry (e.g., as noted above) to acquire data measurements along the surfaces of the vehicle 130 incrementally as the booth is moved to a series of positions. At each position, the mobile scanning booth is unmoved or stationary, and a corresponding scanner module can be controlled to take a raw image of at least one section of the vehicle 130 (e.g., one or more panels). In some embodiments, an example scanning system can be configured and performed as described in an International Application No. PCT/US2019/000003, entitled “Vehicle Surface Scanning System” and filed on Jan. 25, 2019, which is commonly-owned and fully incorporated herein by reference.

In some embodiments, a user can be an inspector for inspecting or checking damages on vehicles. The user can be a PDR technician or any other bodywork technician. The user can be also a representative of a vehicle evaluation/repair shop or a representative of the insurance company. The user can be assigned to assess damages on the vehicle 130. The vehicle 130 can be damaged at a remote location away from the vehicle evaluation/repair shop or any other inspection or scanner systems. The user can carry the portable computing device 120 to inspect the vehicle 130. The user can mark (e.g., scribe or draw) specific shapes on vehicle panels for damage areas (e.g., hail dents) under hail lighting conditions. The shapes can be pre-defined by the user or rules to represent different damage categories. For example, the shapes can include solid dots, circles, or rectangles. The damage categories can include small dents (like dime, nickel, or half dollar sized dents), over-sized dents, and prior damage or non-hail dents. In some embodiments, solid dots are used to indicate small dents, circles are used to indicate over-sized dents, and rectangles are used to indicate prior damages or non-hail dents.

The portable computing device 120 can be configured to capture images and/or process images and/or data. The user can use the portable computing device 120 to capture an image of at least one section of the vehicle 130 when the user carrying the portable computing device 120 moves to the at least one section of the vehicle 130. The user can move around the vehicle 130 to capture images of a plurality of sections (or panels) of the vehicle 130. In some embodiments, the portable computing device 120 installs or integrates a mobile application. The mobile application can be configured to instruct the user to capture, e.g., sequentially, sectional images of the vehicle 130. The portable computing device 120 can include at least one processor configured to execute instructions, at least one memory configured to store data, and an imaging module configured to capture images and/or videos. The portable computing device 120 can include one or more cameras, e.g., one or more consumer grade cameras like smartphone cameras or DSLR cameras, one or more specialist or high resolution cameras, e.g., active or passive stereo vision cameras, Gigapixel monocular or single vision cameras etc., or a combination of specialist and consumer grade cameras. In some embodiments, one or more cameras are external to the portable computing device 120 and can be used to capture the images and transmit the images to the portable computing device 120 or the service computing system 110. The portable computing device 120 can include a communication module configured to communicate with any other computing devices. The portable computing device 120 can communicate via a wireless network, e.g., cellular network, wireless, Bluetooth, NFC or other standard wireless network protocol. The portable computing device 120 can alternatively or additionally be enabled to communicate via a wired network, e.g., via a computer network cable (e.g., CAT 5, 6 etc.), USB cable. In some embodiments, an example portable computing device can be configured and performed as described in U.S. patent application Ser. No. 17/589,453, entitled “ASSESSING DAMAGES ON VEHICLES” and filed on Jan. 31, 2022, which is commonly-owned and fully incorporated herein by reference.

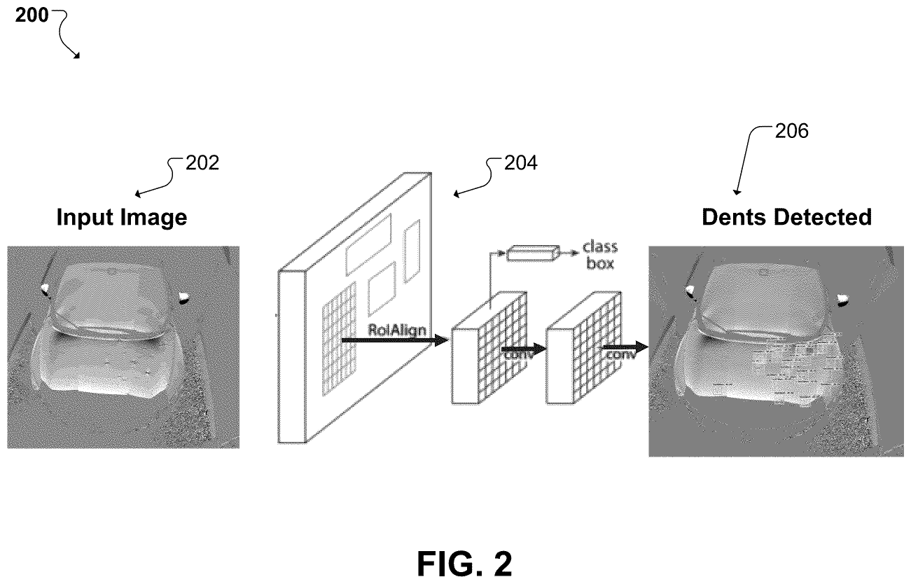

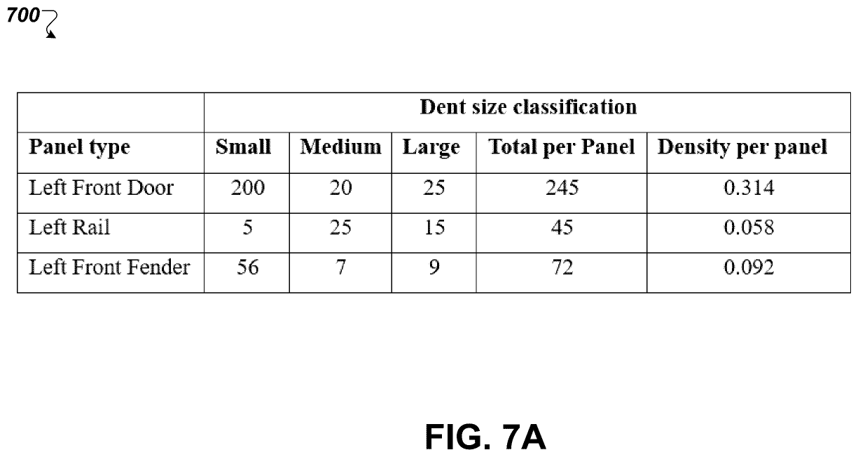

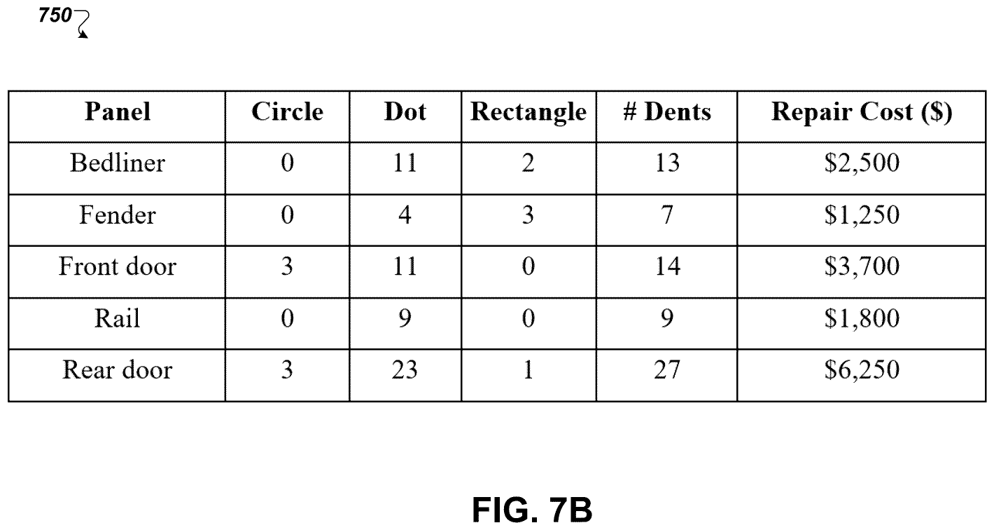

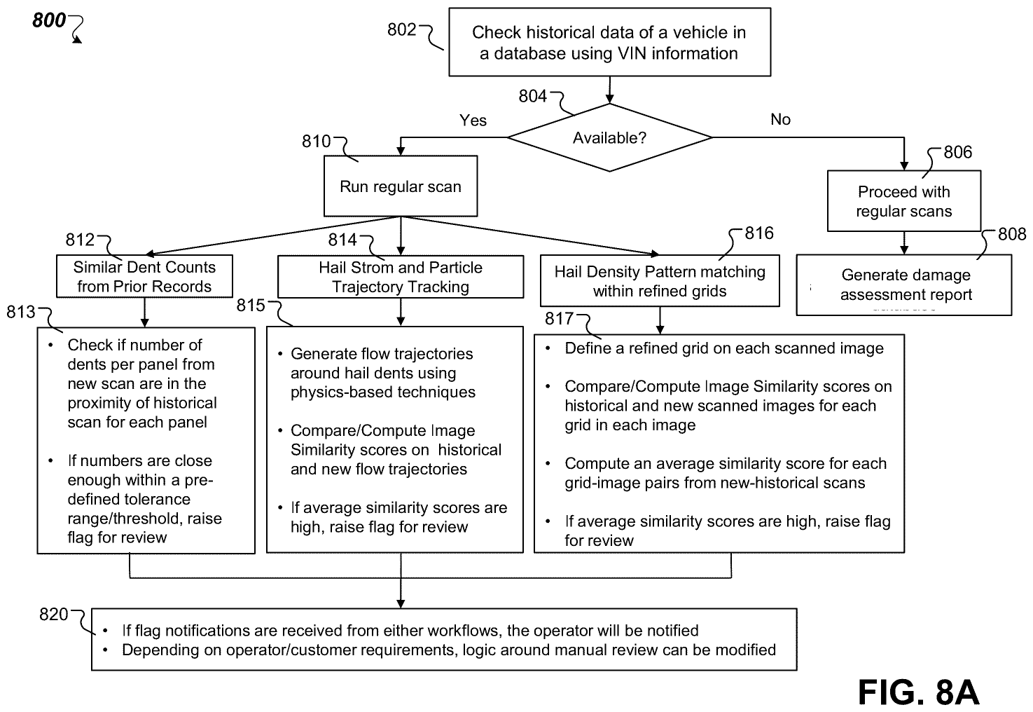

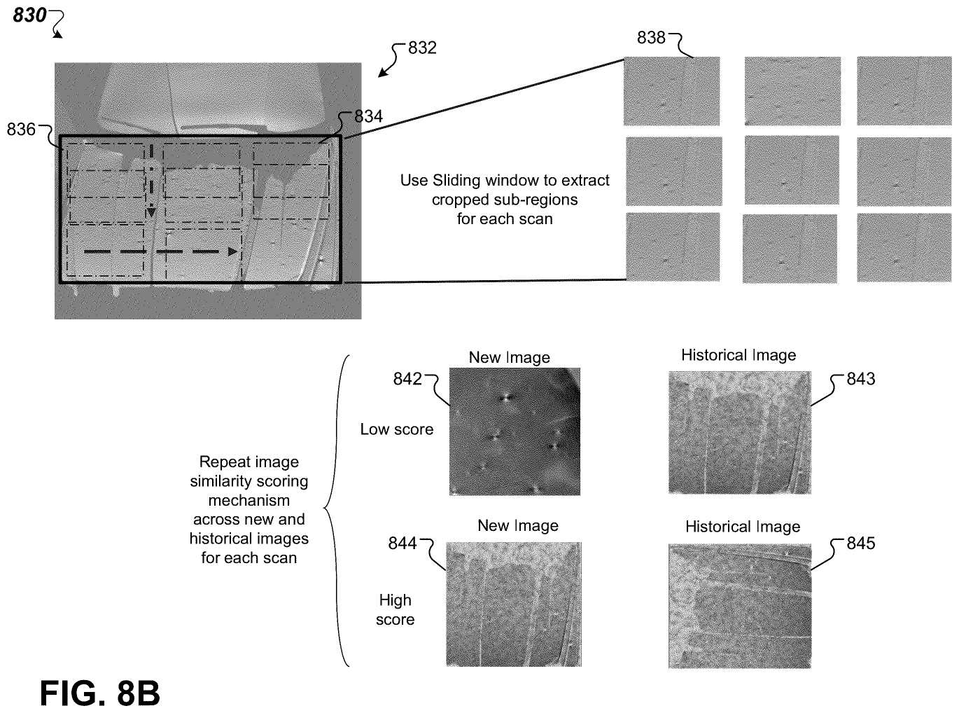

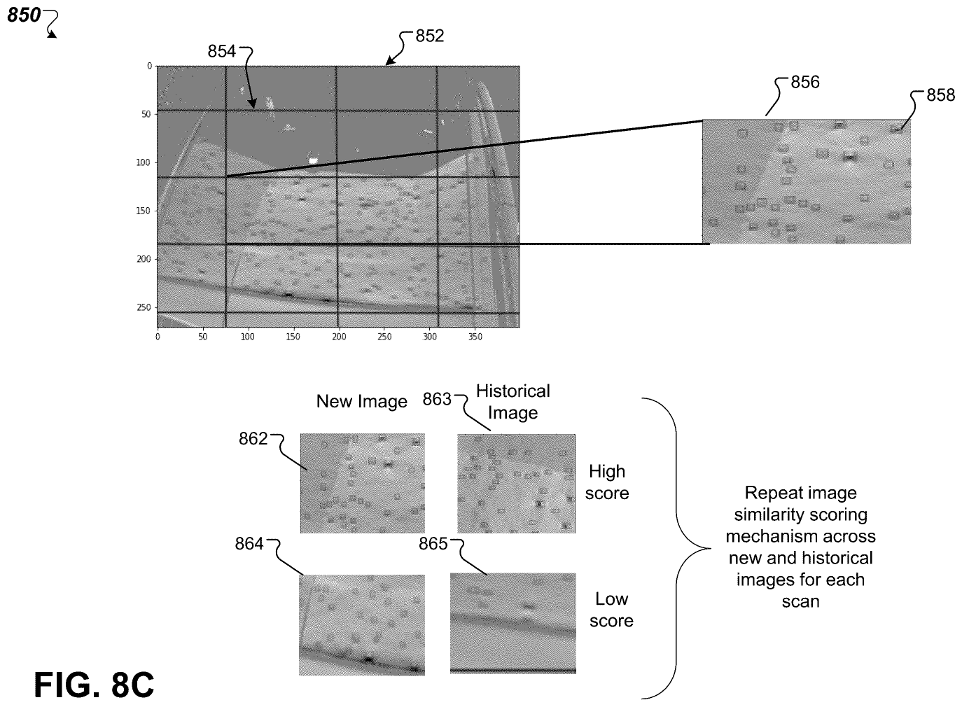

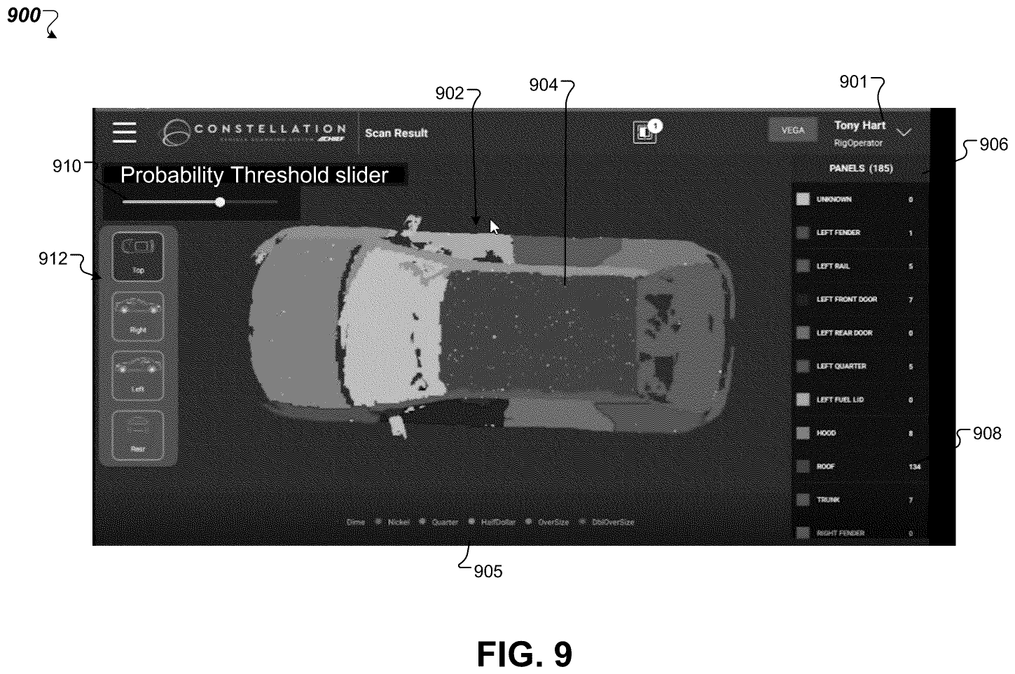

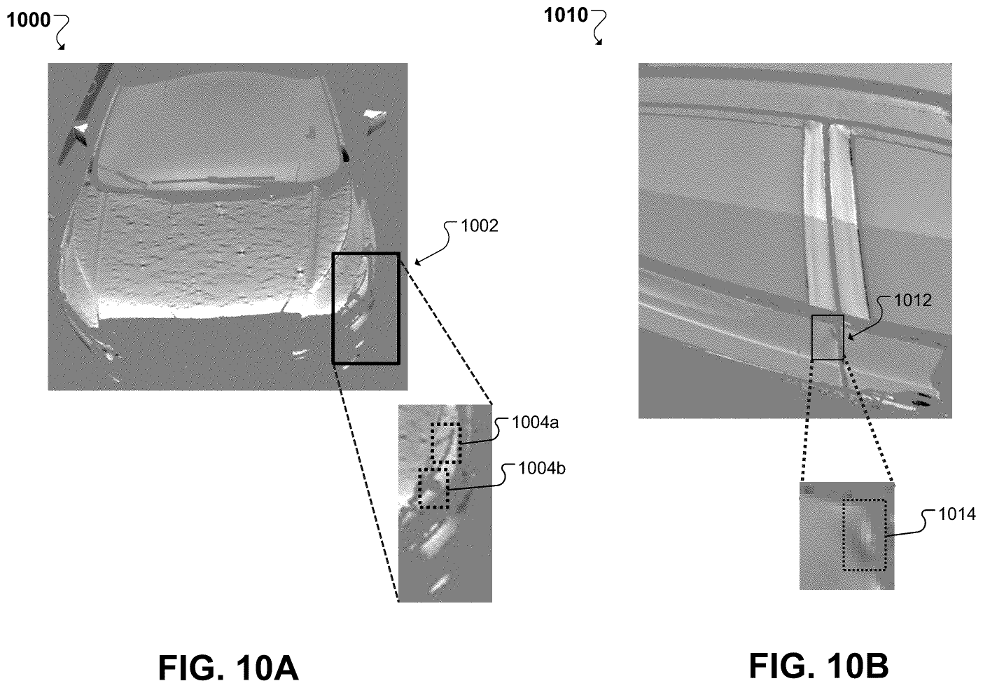

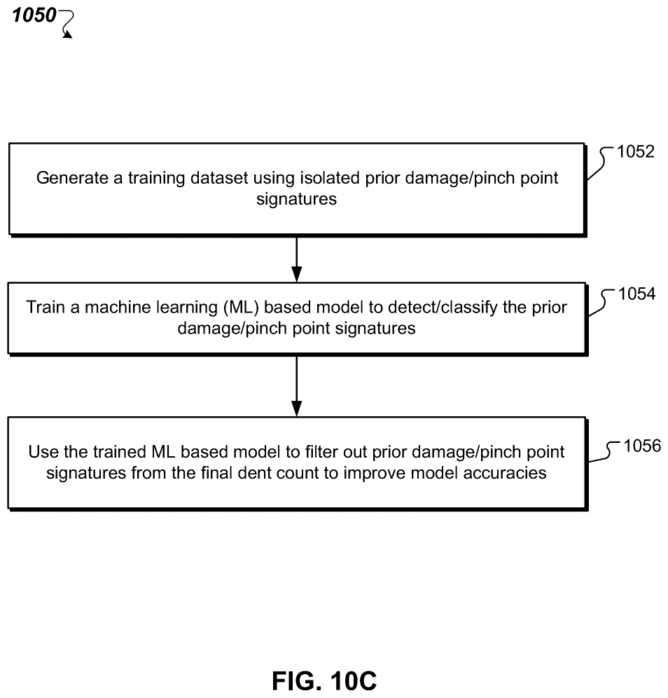

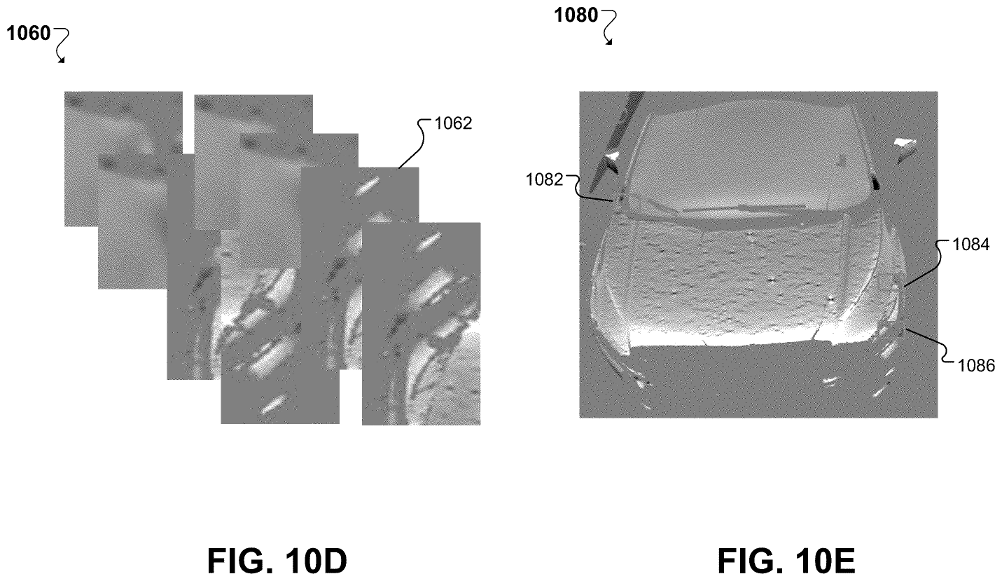

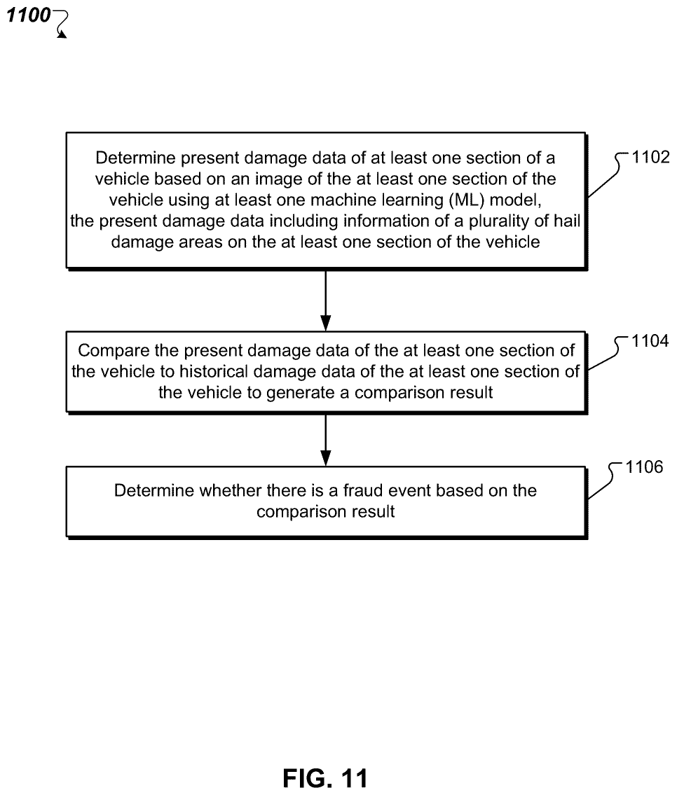

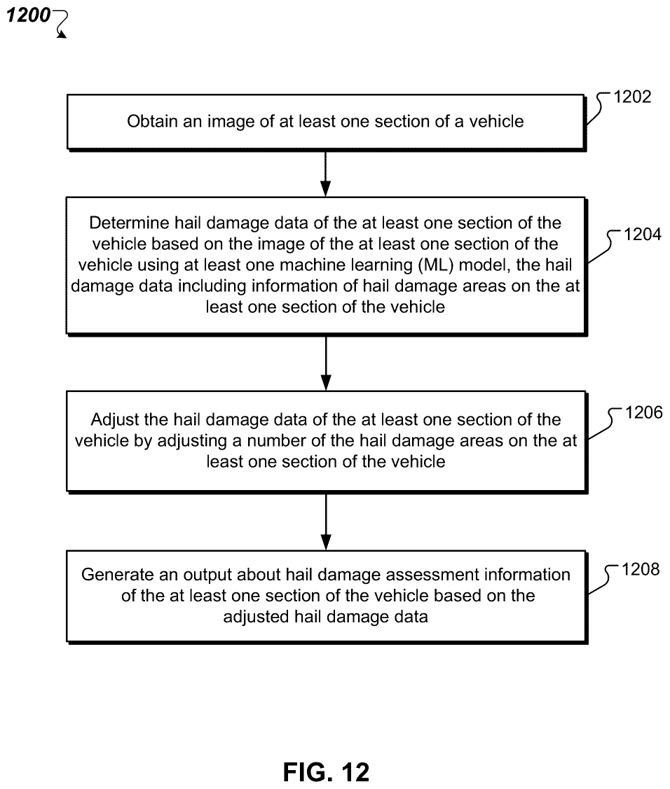

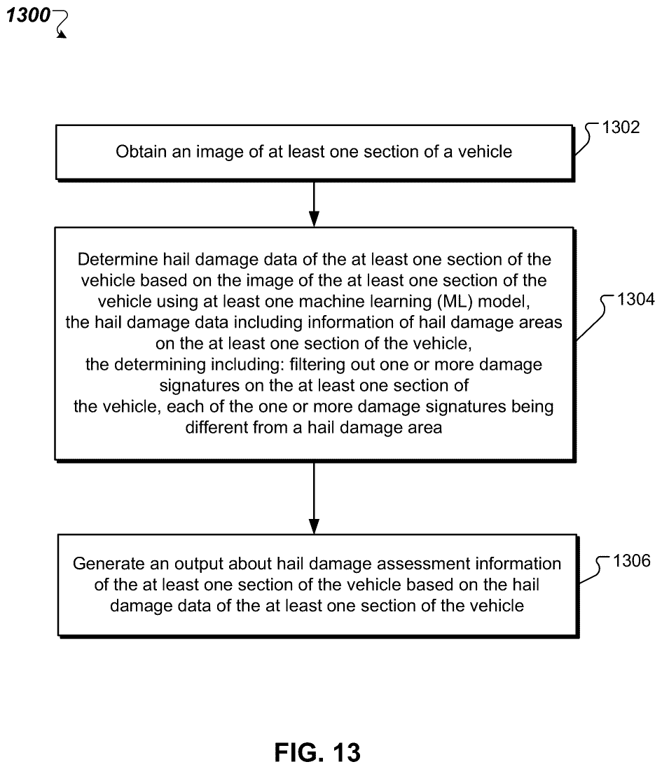

After obtaining an image of at least one section of the vehicle 130, e.g., by the scanning system 140, the portable computing device 120, or an additional image capturing device, the image can be processed using one or more algorithms or models (e.g., a glare reduction model, a shape detection model, and/or a panel detection model). For example, as discussed with further details in FIGS. 2-6, the image can be processed to identity hail damage areas on the at least one section of the vehicle 130, to identity one or more panels in the at least one section of the vehicle 130, and to generate hail damage data by correlating the hail damage areas and the one or more panels to determine, for each of the one or more panels of the vehicle, one or more respective hail damage areas that are present on the panel, e.g., as illustrated in FIGS. 7A-7B. The hail damage data can be then processed to determine whether there is any fraud event, e.g., as illustrated with further details in FIGS. 8A-8C and FIG. 11. The hail damage data can be also adjusted or tuned, e.g., by a probability threshold as illustrated with further details in FIG. 9 and FIG. 12. The hail damage data can be also filtered to remove damage signatures that are not related to hailstorms/dents, e.g., as illustrated with further details in FIGS. 10A-10E and FIG. 13. In the present disclosure, the term “damage signature” represents a particular damage area on a particular location of a vehicle that is not caused by hailstorm. The damage signature can be a damage, pinch point, or mechanical dent caused by metal deformation, e.g., at a head-tail light, a windshield, or a door-window interface.

In some examples, the service computing system 110 operates to provide image processing services to computing devices associated with entities, such as the computing devices 106, 108, 120 for vehicle evaluation/repair shops or insurance companies. The computing devices 108 or the scanning system 140, and/or the portable computing device 120 can transmit images of vehicles to the service computing system 110 through the network 104, and the service computing system 110 can include an application configured to process images to assess damages on vehicles, including generating the hail damage data, determining fraud event, tuning the hail damage data, and/or filtering the hail damage data.

The application of the service computing system 110 can process images using one or more models including a glare reduction model, a shape detection model, and a panel detection model. The glare reduction model can be configured to remove or reduce any glare or bright spots on images, e.g., using mask-based techniques including global binarization with Gaussian Blurr-Dilation-Erosion, in painting, or contrast limited adaptive histogram equalization (CLAHE). The shape detection model is configured to detect shapes or objects shown in the images and can include at least one of You Only Look Once (YOLO), single-shot detector (SSD), Faster Region-based Convolutional Neural Network (Faster R-CNN), or any object detection model. The panel detection model is configured to segment and mask vehicle panels, and can include at least one of masked R-CNN, thresholding segmentation, edge-Based segmentation, region-based segmentation, watershed segmentation, clustering-based segmentation, or any image segmentation model. These models can be trained using any suitable machine learning algorithms, deep learning algorithms, neural networks, or artificial networks.

The application of the service computing system 110 can be also configured to determine whether there is a fraud event based on the hail damage data, e.g., by comparing a similarity between the hail damage data of the vehicle and historical hail damage data of the vehicle. The application can retrieve historical hail damage data of the vehicle from the databases 112. Processed image data, damage data, and/or fraudulent data (e.g., fraud events) about the vehicle can be also stored in the databases 112.

The databases 112 associated with the service computing system 110 can be configured to store respective vehicle data associated with vehicles, vehicle owners, insurance companies, and/or vehicle evaluation/repair shops. The respective vehicle data of a vehicle can include a vehicle identifier (e.g., vehicle identification number-VIN) of the vehicle and vehicle information such as color, shape, size, type, and/or model. The respective vehicle data can also include sectional images of sections of the vehicle, and/or historical sectional images of the vehicle. The respective vehicle data can also include damage data of the vehicle (e.g., historical hail damage data on at least one section of the vehicle, historical dent counts per panel, historical flow trajectories of damage areas, and/or historical image portions of an area of interest in the at least one section of the vehicle). The respective vehicle data can also include repair estimate data (or estimate cost data for damage repair) for the vehicle, and/or filed insurance claims for at least one section of the vehicle.

In some embodiments, the service computing system 110 hosts one or more applications for users to download and install, enabling use of the trained models, e.g., for performing model inference that includes processes of running data into one or more corresponding machine learning algorithms to calculate outputs. The applications can run on any suitable computing devices, e.g., the computing device 108 or the portable computing device 120. For example, a windows or Mac application can be developed to install and run on the computing device 108 (e.g., a laptop or desktop computer). A mobile application can be developed to install and run on the portable computing device 120 such as a mobile phone or tablet. The mobile application can be obtained by converting deep-learning models that run on computers or servers to mobile compatible versions. For example, for mobile-edge deployment on iOS or Android platforms, the shape-detection model (e.g., YOLO) and/or the panel detection model (e.g., masked R-CNN) models can be converted to tf-lite versions. There are other platforms (e.g., PyTorch Mobile, MACE, Core-ML) that can convert the deep-learning models to mobile compatible versions.

In some embodiments, similar to the service computing system 110, an application can be installed and run on the computing device 108 or the portable computing device 120. The application can be a software application including machine-executable instructions. The application can be configured to obtain images and process images to assess damages on vehicles, including generating the hail damage data, determining fraud event, tuning the hail damage data, and/or filtering the hail damage data. As described with further details below, the application can search and download vehicle data or historical damage data of a vehicle (e.g., based on VIN of the vehicle) from the databases 112, and determine the fraud event for the vehicle on the computing device 108 or the portable computing device 120. The computing device 108 or the portable computing device 120 can transmit determined fraudulent data or information of the vehicle to the service computing system 110 and/or the databases 112 for storage.

In some embodiments, the application running on the computing device 108 or the portable computing device 120 is configured to obtain images and process images to obtain the hail damage data, including generating the hail damage data, tuning the hail damage data, and/or filtering the hail damage data. The hail damage data can be transmitted to the service computing system 110, and the application on the service computing system 110 can process the hail damage data, including determining fraud event, tuning the hail damage data, and/or filtering the hail damage data.

In some embodiments, the application running on the computing device 108 or the portable computing device 120 can further include a report generation module. The application can generate a damage assessment report (or a repair estimate report) using the report generation module based on outputs from the models, e.g., shape data and panel data. In some embodiments, the damage assessment report includes counts of different shapes (or damage categories) per vehicle panel, e.g., as illustrated in FIG. 7A or 7B. In some embodiments, the damage assessment report can further include repair estimate costs, e.g., as illustrated in FIG. 7B.

In some embodiments, the application running on the computing device 108 or the portable computing device 120 can generate the damage assessment report by processing the shape data and panel data with repair estimate data (or estimate cost data for damage repair). The repair estimate data can associate damages (different categories and different numbers), vehicle types, vehicle models, panel types, with corresponding estimated costs. The repair estimate data can be provided by a repair shop, an insurance company, a provider, or by an industry standard or rule. The repair estimate data can be stored in a database, e.g., in the databases 112, or in a memory of the computing device 108 or the portable computing device 120. The computing device 108 or the portable computing device 120 can access the database external to the computing device 108 or the portable computing device 120. In some embodiments, a repair estimate application can be developed based on the repair estimate data. In some embodiments, the computing device 108 or the portable computing device 120 can integrate the application (for model inference) and the repair estimate application to generate the damage assessment report (or the repair estimate report). In some embodiments, the service computing system 110 can also process panel data, shape data, and/or repair estimate data to generate a damage assessment report. The service computing system 110 can then provide the damage assessment report to the computing device 108 or the portable computing device 120. After the damage assessment report is generated either by the computing device 108 or the portable computing device 120 or the service computing system 110, the computing device 108 or the portable computing device 120 can transmit the damage assessment report to the computing device 106 for a representative of the insurance company to view.

### Example Image Processing

FIG. 2 is a schematic diagram 200 of an example of dent detection for a vehicle (e.g., the vehicle 130 of FIG. 1). The dent detection can be performed by an application running on a computing device, e.g., the portable computing device 120 or the computing device 108 of FIG. 1, or a computing system such as the computing system 110 of FIG. 1.

An input image 202 is received. The input image 202 can be an image of at least one section of the vehicle. The image can be obtained at a scanning position by a scanning system (e.g., the scanning system 140 of FIG. 1) or an image capturing device (e.g., the portable computing device 120 of FIG. 1). The image can be selected from a stereo image or a monocular image. In some examples, the image can be an image from one or more high resolution cameras. In other examples, the image can be an image from one or more consumer grade cameras e.g., a cell-phone camera, D-SLR or other appropriate camera.

The input image 202 can have undergone various pre-processing steps prior to being input for the dent detection. In some embodiments, the input image 202 can be an output of a glare reduction model and/or a result of pre-processing. The pre-processing can include removing background features, removing noise, converting the image to greyscales, etc. The glare reduction model can be trained through a machine learning algorithm to reduce surface glare of the vehicle in the image. The input image 202 can be converted to a binary image prior to undergoing processing.

The input image 202 undergoes processing at a machine learning model 204. The machine learning model 204 was previously trained using a training data set that is labelled and/or masked to train the machine learning model 204 to detect a plurality of hail dents (or hail damage areas). The machine learning model 204 can categorize a hail dent, e.g., according to its size such as small, medium, or large. The machine learning model 204 can include at least one of: You Only Look Once (YOLO), single-shot detector (SSD), Faster Region-based Convolutional Neural Network (Faster R-CNN), or a computer vision algorithm.

In some examples, the input image 202 can be converted into a feature map and undergo one or more convolutions and/or regressions to output one or more classifications and one or more bounding boxes and/or masks associated with one or more detected areas of hail damage in the input image 202. An output image 206 can be generated which indicates the one or more identified areas of hail damage on the received input image 202, e.g., as shown in FIG. 2.

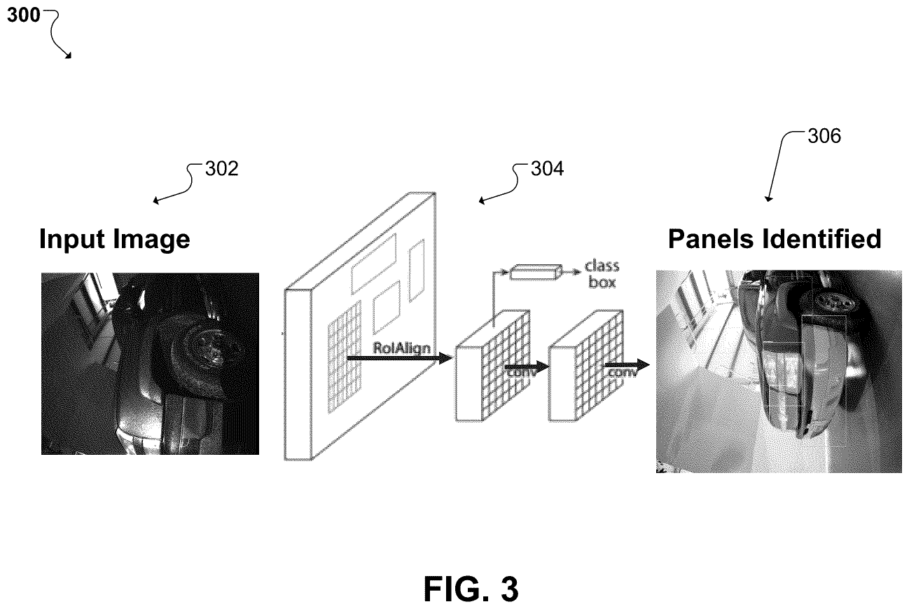

FIG. 3 is a schematic diagram 300 of an example of panel identification for a vehicle (e.g., the vehicle 130 of FIG. 1). The panel identification can be performed by an application running on a computing device, e.g., the portable computing device 120 or the computing device 108 of FIG. 1, or a computing system such as the computing system 110 of FIG. 1.

An input image 302 is received. The input image 202 can be an image of at least one section of the vehicle. The image can be obtained at a scanning position by a scanning system (e.g., the scanning system 140 of FIG. 1) or an image capturing device (e.g., the portable computing device 120 of FIG. 1). The image can be selected from a stereo image or a monocular image. In some examples, the image can be an image from one or more high resolution cameras. In other examples, the image can be an image from one or more consumer grade cameras e.g., a cell-phone camera, D-SLR or other appropriate camera.

In some examples, the input image 302 for panel identification is same as the input image 202 for dent detection of FIG. 2. In some other examples, the input image 302 for panel identification is different from the input image 202 for dent detection. For example, the input image 302 can be initial image or raw image, while the input image 202 can be an image after pre-processing.

The input image 302 undergoes processing at a machine learning model 304. The machine learning model 304 were previously trained using a training data set that is labelled and/or masked to train the machine learning model 304 to detect panels of a vehicle. The machine learning model 304 can include at least one of: masked R-CNN, thresholding segmentation, edge-Based segmentation, region-based segmentation, watershed segmentation, or clustering-based segmentation. In some examples, the input image 302 is converted into a feature map and undergoes one or more convolutions and/or regressions to output one or more classifications and one or more bounding boxes and/or masks associated with panel classifications in the input image 302. An output image 306 can be generated which indicates, e.g., using a mask generated by a neural network, one or more identified panels in the image, e.g., as illustrated in FIG. 3.

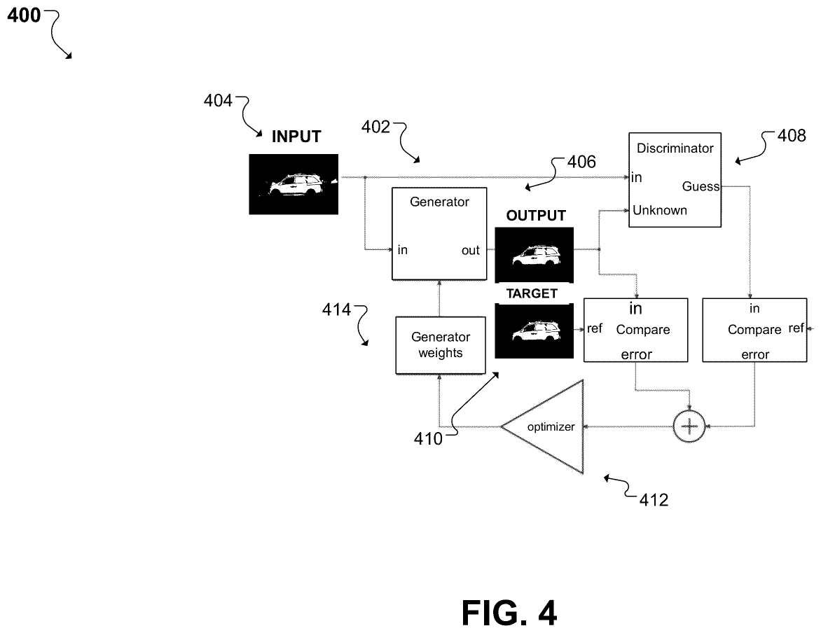

FIG. 4 is a schematic diagram of an example system 400 for reducing noise in images for damage detection. The system 400 can be included in a computing device, e.g., integrated in an application running on the computing device. The computing device can be the computing device 108, the portable computing device 120, or a computing device in the service computing system 110.

The system 400 can use a Generative Adversarial Network (GAN). In a GAN, two neural networks are used in competition. The generator network 402 receives an input image 404 and generates a new output image 406 from the input image 404 using learned parameters. The output image 406 is passed to a discriminator network 408 to predict whether the output image 406 has been generated by the generator network 404 or is a real image. The output image 406 can be used as the input image 202 of FIG. 2 and/or the input image 302 of FIG. 3.

During training, the two networks are trained on an objective function that causes the two networks to “compete” with each other, the generator network to fool the discriminator network and the discriminator network to correctly predict which images are real. The generator network is therefore trained to effectively perform a specific task, e.g., remove noise from an image. In an initial training phase, the training data set can be, for example a set of images to which noise has been artificially added. The training data set can include noise and/or artifacts that are associated with dents and/or panels and can also include noise and/or artifacts that are not associated with any panels.

The generator network 402 can be trained to remove the noise from the image. The discriminator network 408 can predict whether the image is an image output by the generator network 402 or whether it is a target image 410 from the ground truth data set, e.g., an image from the data set that includes the images prior to the noise being artificially added. A first comparison can be made between the target image 410 and the output image 406 and a second comparison can be made between the target image 410 and the prediction of the discriminator network 408. The comparisons can be passed to an optimizer 412 which updates the weights 414 of the generator network and the discriminator neural network to optimize a GAN objective.

In a first implementation, the GAN objective can include finding an equilibrium between the two networks {Generator (G) and Discriminator (D)} by solving a minimax equation as indicated below:

$${min}_{θ} {max}_{ϕ} V ( {G}_{θ} , {D}_{ϕ} ) = {𝔼}_{x \sim {P}_{data}} [ log {D}_{ϕ} ( x ) ] + {𝔼}_{z \sim p ( z )} [ log ( 1 - {D}_{ϕ} ( {G}_{θ} ( z ) ) ) ] .$$

This equation is known as minimax equation (derived from KL-divergence criterion) as it is trying to jointly optimize two parameterized networks, G (Generator) and D (Discriminator), to find an equilibrium between the two. The objective is to maximize the confusion of D while minimizing the failures of G. When solved, the parameterized, implicit, generative data distribution can match the underlying original data distribution fairly well.

In a further implementation, the generative model is configured to come up with a procedure of matching its generated distribution to a real data distribution so it can fake the discriminator network. Minimizing the distance between the two distributions is critical for optimizing the generator network so it can generate images that are identical to a sample from the original data distribution (p(x)). To measure the difference between the generated data distribution (q(x)) and the actual data distribution (p(x)), there are multiple objective functions. For example, Jensen Shannon Divergence (JSD) {derived from Kullbach-Liebler Divergence (KLD)}, Earth-Mover (EM) distance (AKA Wasserstein distance) and Relaxed Wasserstein GAN to name a few.

The trained generator network 402 can then be used to generate de-noised input images for input into one or more or of a panel detection neural network and a dent detection neural network. The images can be, for example, a set including a mix of image formats, and the further neural network is trained on a data set including a mix of image formats. The output image 406 can be de-noised binary images.

### Example Processes for Assessing Damages on Vehicles

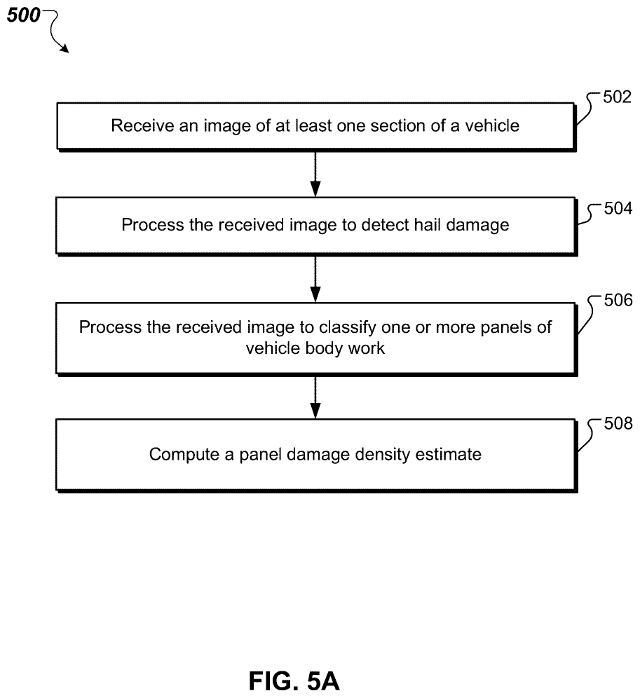

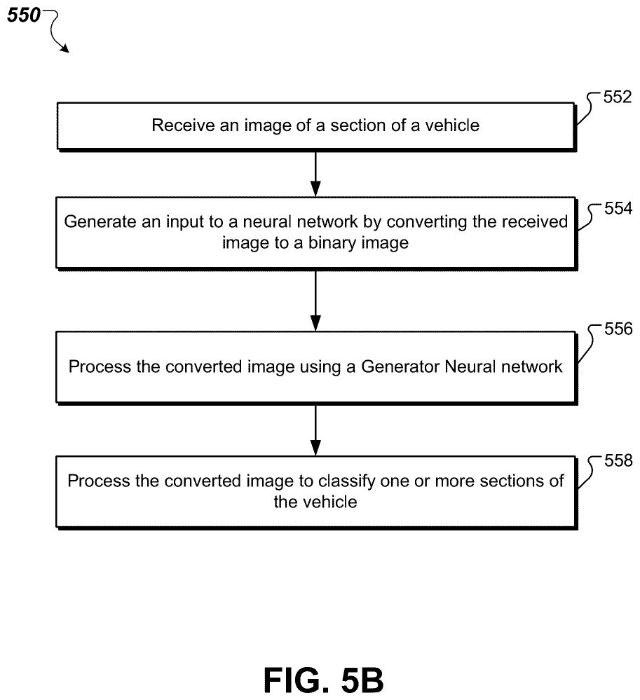

FIG. 5A shows a flow diagram of an example process 500 for damage density determination. The process 500 can be performed by an appropriately programmed system of one or more computers located in one or more locations, e.g., the computing device 108 of FIG. 1 and/or a computing device in the service computing system 110 of FIG. 1.

An image of at least one section of a vehicle is received (502). The vehicle can be the vehicle 130 of FIG. 1. The image can be an image of one or more panels (or parts) of the vehicle, e.g., fender, door, wheel arch, etc. The image can be a three-dimensional stereo image, a monocular image, or any other appropriate image.

The received image is processed to detect a plurality of hail damage areas on the section of the vehicle and to classify each of the plurality of areas of damage according to the seriousness of the damage (504), e.g., as described in FIG. 2. Detecting the plurality of hail damage areas can include detecting a plurality of damaged areas distributed over an entire section of the vehicle and differentiating the plurality of damaged areas from one or more areas of noise. Sources of noise can include dust particles, dirt, specular reflection, flaws in paint, etc. Each damage area can be classified into a different type of categories, e.g., size or shape. In some example, a damage area is classified by size into small, medium, or large, e.g., as illustrated in FIG. 7A. The detection can be done using a neural network, a machine learning technique, or an algorithm, e.g., You Only Look Once (YOLO), single-shot detector (SSD), Faster Region-based Convolutional Neural Network (Faster R-CNN), or a computer vision algorithm.

The received image is processed to classify one or more sections of the vehicle as one or more panels of the vehicle bodywork (506), e.g., as described in FIG. 3. The classification or identification can use a further neural network, a machine learning technique, or an algorithm, e.g., masked R-CNN, thresholding segmentation, edge-Based segmentation, region-based segmentation, watershed segmentation, or clustering-based segmentation.

A panel damage density estimate is computed based on the detected areas of damage, the classification of the seriousness of the damage, and the classification of the one or more panels (508). The panel damage density estimate can be a table 700 as shown in FIG. 7A. The table can include, for each panel, a number of dents for each classified type (small, medium, or large), a total number of dents on the panel, and a dent density of the panel (e.g., based on the total number of dents and an area of the panel).

In some embodiments, the received image can be pre-processed to generate a standard image, for example, a binary image. The binary image can also have noise removed. Pre-processing can include converting the image using a generator neural network to generate a modified image, where the generator neural network has been trained jointly with a discriminator neural network to generate modified images that have reduced image noise relative to input images to the generator neural network, e.g. as described in. FIG. 4 and FIG. 5B.

In some embodiments, the system processes the received image using a neural network, for example, a masked R-CNN. Although a masked RCNN is one example of an appropriate technique for classifying hail damage according the size and seriousness of the damage, the skilled person will be aware that other implementations are possible, for example, other neural network implementations e.g. Fast RCNN, YOLO, or non-neural network based Machine Learning techniques e.g. random forests, gradient boosting etc.

A masked R-CNN is a deep neural network. It can include a bottom-up pathway, a top-bottom pathway and lateral connections. The bottom-up pathway can be any convolutional neural network which extracts features from raw images, e.g., ResNet, Visual Geometric Group (VGG), etc. The top-bottom pathway (e.g., forward pass) generates a feature map. The forward pass of the CNN results in feature maps at different layers, e.g., building s multi-level representation at different scales. Top-down features are propagated to high resolution feature maps thus having features across all levels The Lateral connections are convolution and adding operations between two corresponding levels of the two pathways.

The masked R-CNN proposes regions of interest in a feature map by using a selective search to generate region proposals for each image using a Region Prediction Network (RPN). In some examples, the masked R-CNN uses a region of interest pooling layer to extract feature maps from each region of interest and performs classification and bounding box detection on the extracted feature maps. The pooling layer converts each variable size region of interest into a fixed size to be fed to a connected layer by performing segmentation and pooling, e.g., max-pooling. Bounding box regression is used to refine the bounding boxes such that class labels and bounding boxes are predicted. In other examples, the R-CNN uses a region of interest alignment layer. The region of interest alignment layer takes the proposed region of interest and dividing it into a specified number of equal size boxes and applying bilinear interpolation inside each box to compute the exact values of the input features at regularly sampled locations, e.g., 4 regularly sampled locations. The masked R-CNN can further generate a segmentation mask. An intersection over union (IoU) is computed for each bounding box with a ground truth bounding box. Where the IoU of a bounding box with a ground truth bounding box is greater than a threshold level the bounding box is selected as a region of interest. The masked R-CNN can then further encode a binary mask per class for each region of interest.

Using the above approach, a plurality of areas of hail damage can be detected on a received image of at least a section of a vehicle using the masked R-CNN. For example, the plurality of bounding boxes can be used to generate a count of the number of detections of hail damage in the received image and the size of the bounding box can be used to generate an estimate of the seriousness of each area of hail damage. Each area of hail damage can further be labelled as, e.g., slight, moderate, severe. Alternatively, the damage can be labelled as small, medium, large etc. The binary mask for each region can be used to compute an overall area effected.

In some embodiments, the system uses a masked R-CNN to generate a respective classification of one or more sections of the vehicle. The masked R-CNN extracts a feature map from the image and executes a regression such that bounding boxes and class labels are extracted from the feature map and the generates a mask is generated that identifies the damaged section of the vehicle. More generally, however, any appropriate machine learning model can be used to perform the classification.

In some embodiments, the system can take the detected panel from the classification of the one or more panel and use the make, model and year of the vehicle to determine the dimensions of the identified panel. The percentage of damage of the identified panel can then be computed and a proportion of the damage that is slight, moderate and severe can be identified. Using the damage density estimate, a user of the system can therefore determine whether it is cost effective to repair the panel or whether the panel should be replaced.

In some embodiments, a first neural network (arranged to detect a plurality of areas of hail damage) and a further neural network (arranged to identify one or more panels in an image of a section of a vehicle) are trained on a data set including a mix of image formats. The images can be annotated with training labels, for example, the training labels can be provided in COCO format. COCO is large scale images with Common Objects in Context (COCO) for object detection, segmentation, and captioning data set. The mix of image formats can include one or more 3-D geometry files, e.g., CAD files. The 3-D geometry files can be augmented with hail damage simulated using impact analysis. Impact analysis make be executed using an appropriate simulation method, e.g., finite element analysis. Examples of commercially available products for finite element analysis include Ansys (Ansys, Inc.) and Abaqus (Dassault Systems). The hail damage can be simulated under different lighting conditions, lighting conditions can be simulated using appropriate lighting techniques, e.g., ray-tracing, ray-casting etc.

FIG. 5B is a flow diagram of an example process 550 for generating images in a standard format for hail damage analysis. The process 500 can be executing using, for example, a GAN network, as described with reference to FIG. 4 above. The process 550 can be used to generate images in a standard format for training a damage detection neural network and/or a panel detection neural network as described above. Alternatively, the process 550 can be used to increase the quality of images fed to a network during a prediction phase. For example, reducing the amount of noise and/or sources of confusion in the image, e.g., noise dust particles, dirt, and/or specular reflection.

An input image is received (552). The input image can be an image of at least a section of a vehicle. The input image can include a plurality of damaged areas distributed over an entire section of the vehicle. The input image can also include one or more areas of noise. The input image can be a 3D geometry file, for example, a CAD file that includes one or more simulated areas of damage.

An input to a neural network is generated by converting the received image to a binary image (554). The input can be the input image 404 of FIG. 4. The converted image is processed using a generator neural network (e.g., the generator network 402 of FIG. 4) to generate a modified image (556). The modified image can be the output image 406 of FIG. 4. The generator neural network has been trained jointly with a discriminator neural network (e.g., the discriminator network 408 of FIG. 4) to generate modified images that have reduced image noise relative to input images to the generator neural network.

The output images can be used as input (e.g., the input image 202 of FIGS. 2 and/or 302 of FIG. 3) to a machine learning model or system to detect hail damage. The machine learning model or system can process the converted image using a further neural network to classify one or more sections of the vehicle as one or more panels of the vehicle bodywork. The machine learning system can further detect a plurality of damaged areas distributed over the entire section of the vehicle and differentiate the plurality of damaged areas from one or more areas of noise.

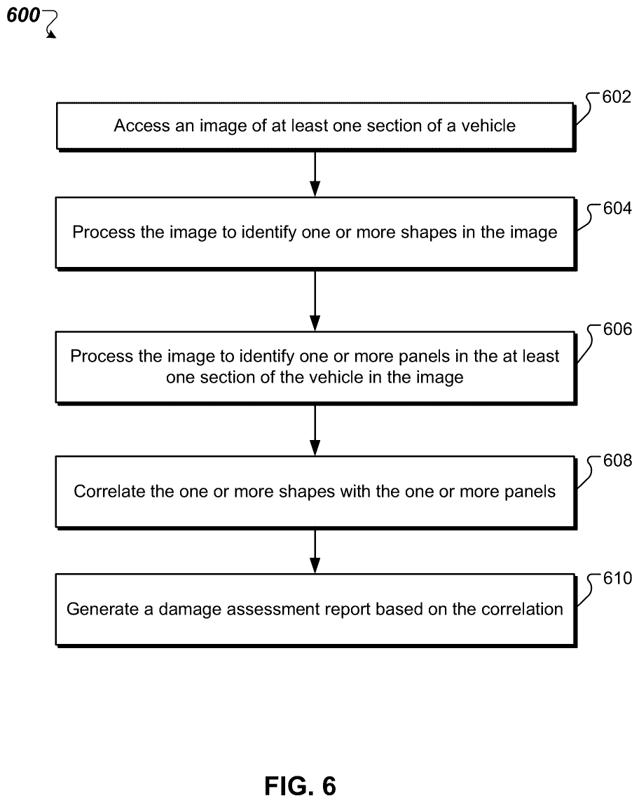

FIG. 6 is a flow chart of an example process 600 for assessing damages on vehicles. The process 600 can be performed by a mobile device (e.g., the portable computing device 120 of FIG. 1), a remote server (e.g., the computing system 110 of FIG. 1), or a combination of the mobile device and the remote server.

An image of at least one section of a vehicle is accessed (602). The image shows a plurality of shapes that each have been applied to indicate at least one damage area present in the at least one section of the vehicle. A user, e.g., the PDR technician, can scribe or annotate the shapes on panels of the vehicle to detect damage areas on the vehicle. Each shape can at least partially cover a different corresponding damage area in the at least one section of the vehicle. The damage areas can include hail dents. The plurality of shapes can have at least two different shape types, e.g., solid dots, circles (or ellipses), and rectangles (or squares). Each of the different shape types corresponds to a different damage category. For example, solid dots represent small dents, circles represents oversized dents, and rectangles represent previous damages or non-hail damages. The user can be recommended to use the shapes to indicate different damage areas. The user can be instructed, e.g., by a mobile application installed on the mobile device, to capture images of vehicle panels.

In some embodiments, the process 600 is performed on the remote server. The remote server can receive the image from the mobile device that captures the image. In some embodiments, the image can be generated based on at least one frame of a video stream for the at least one section of the vehicle.

In some embodiments, the image can be an output of a glare reduction model and/or a result of pre-processing. The pre-processing can include removing background features, removing noise, converting the image to greyscales, etc. The glare reduction model can be trained through a machine learning algorithm to reduce surface glare of the vehicle in the image.

In some embodiments, the image is generated based on multiple sectional images of the vehicle, each of the multiple sectional images being associated with a different corresponding section of the vehicle. For example, a roof can be divided into two sections, and each section is captured in a separate image. Then the separate images of the two sections can be combined to get an image of roof.

In some embodiments, an instruction can be displayed on a display of the mobile device for capturing a sectional image of a section of the vehicle. In some embodiments, in response to obtaining a captured sectional image of the section of the vehicle, the process 600 can include determining whether the captured sectional image reaches an image criteria for the section of the vehicle.

In some embodiments, the captured sectional image is processed to detect information of glare or bright spot on the section of the vehicle, and then the mobile device can determine whether the detected information of glare or bright spot is below a predetermined threshold.

In response to determining that the captured sectional image fails to reach the image criteria for the section of the vehicle, the mobile device can display an indication on the display for retaking the sectional image of the section of the vehicle. In response to determining that the captured sectional image reaches the image criteria for the section of the vehicle, the mobile device can store the captured sectional image for further processing.

The image is processed to identify one or more shapes in the image (604). The image can be provided as input to a first model that has been trained, through a first machine learning algorithm, to identify the plurality of shapes in the image and, in response, shape data is generated by the first model. The shape data can describe a position of each of one or more shapes identified in the image. The shape data can include a corresponding shape type for each of the one or more shapes identified in the image. In some embodiments, the first model can be a shape detection model that includes at least one of: You Only Look Once (YOLO), single-shot detector (SSD), Faster Region-based Convolutional Network (Faster R-CNN), or any suitable object detection model. The first model can be pre-trained to accurately identify different types of shapes.

In some embodiments, the shape data includes, for each of the one or more shapes, a corresponding label (e.g., number 0, 1, 2) for the corresponding shape type of the shape. The process 600 can further include: for each of the one or more panels, counting, based on the corresponding labels, a number of identified shapes that are correlated with the panel and have a same corresponding shape type. In some embodiments, the first model is trained to process the image to enclose a corresponding bounding box for each of the one or more shapes identified in the image and to determine the position of the shape based on a position of the corresponding bounding box.

The image is processed to identify one or more panels in the at least one section of the vehicle in the image (606). The image can be provided as input to a second model that has been trained, through a second machine learning algorithm, to identify the one or more panels of the vehicle that are present in the at least one section shown in the image, and in response, panel data is generated by the second model. The panel data can describe a position of each of the one or more panels identified in the image. The second model can include at least one of: masked R-CNN, thresholding segmentation, edge-Based segmentation, region-based segmentation, watershed segmentation, clustering-based segmentation, or any image segmentation algorithm. In some embodiments, the second model is trained to process the image to segment the at least one section of the vehicle into the one or more panels by masking one or more segments of the image and isolating the masked one or more segments of the image as the one or more panels, each of the masked one or more segments being associated with a corresponding one of the one or more panels.

The one or more shapes and the one or more panels are correlated, e.g., automatically, based on the shape data and the panel data to determine, for each of the one or more panels of the vehicle, a number of shapes that are present on the panel (608).

In some embodiments, each of the one or more shapes can be correlated with a respective panel of the one or more panels based on the position of the shape and the position of the respective panel. In some embodiments, each of the one or more shapes can be correlated with a respective panel of the one or more panels based on the position of the shape and a masked segment associated with the respective panel. In some embodiments, for each of the one or more panels, the process 600 can further include: classifying one or more identified shapes correlated with the panel according to one or more corresponding shape types for the one or more identified shapes, and for each of the one or more corresponding shape types, counting a respective number of identified shapes that are correlated with the panel and have a same corresponding shape type.

A damage assessment report is generated, which describes, for each of the one or more panels of the vehicle, the number of shapes that are present on the panel (610). The process 600 can include: generating shape-damage correlation data based on the one or more panels, the one or more corresponding shape types for each of the one or more panels, and the respective number for each of the one or more corresponding shape types.

In some embodiments, estimate cost data for damage repair is accessed. The estimated cost data is associated with at least one of damage categories, a number of damage areas in a same damage category, different panels, or vehicle models. The damage assessment report can be generated based on the shape-damage correlation data and the estimated cost data for damage repair. FIG. 7B shows an example table 750 in the damage assessment report, which can include, for each panel, a respective dent count for each shape type (e.g., circle, dot, rectangle) that corresponds to a different category type (e.g., small, medium, or large), a total dent count for the panel, and a corresponding repair cost for repairing the dents on the panel.

In some embodiments, after the damage assessment report is generated, the damage assessment report can be provided, e.g., by transmitted through a network such as the network 104 of FIG. 1, to at least one of a repair shop representative or a vehicle insurance company representative.

### Example Fraud Detection

FIG. 8A is a flow chart of an example process 800 for fraud detection, e.g., for hail damage on vehicles. The process 800 can be performed by at least one computing device, e.g., the computing device 108 of FIG. 1, the portable computing device 120 of FIG. 1, and/or a computing device in the service computing system 110 of FIG. 1. The process 800 can be performed by at least one application running on the at least one computing device. As discussed with further details below, the at least one application can be configured to perform fraud detection with one or more mechanisms, including checking similar dent counts, checking hail Strom and particle trajectory tracking, and/or checking hail density pattern matching within refined grids.

A user (e.g., a PDR technician or a vehicle evaluation/repair shop operator) assessing damage on a vehicle can use a computing device (e.g., the computing device 108 of FIG. 1 or the portable computing device 120 of FIG. 1) to first check historical data of the vehicle in a database based on identification information of the vehicle (802). The identification information of the vehicle can include vehicle identification number (VIN) of the vehicle, which is unique to the vehicle. The database can be a database associated with the computing device (e.g., externally coupled to the computing device) or a database (e.g., in the database(s) 112 of FIG. 1) associated with a service computing system (e.g., the service computing system 110 of FIG. 1).

The service computing system can communicate with a plurality of computing devices associated with different users and provide services to the different users. The service computing system can store vehicle data and/or customer data in the database. The vehicle data can include identification information, vehicle model, year, type, historical damage data of the vehicle previous repair history, previous insurance claim, vehicle owner information, and/or insurance information. The customer data can include a vehicle owner's name, address, phone number, identification information (e.g., driver license number), one or more vehicles associated with the customers, insurance information, and/or filed insurance claim(s). The users can register vehicles in the database. The users can also use the computing devices to add or update vehicle data and/or customer data to the database, and/or to download vehicle data and/or customer data from the database.

The computing device determines whether the historical data of the vehicle is available in the database (804). As discussed with further details below, the historical data of the vehicle can include historical damage data (e.g., total dent count, dent count per panel and/or per size or category, raw sectional images, processed sectional images, and/or flow trajectory images) and/or historical insurance claims.

If the historical data of the vehicle is unavailable in the database, the computing device proceeds to perform with regular scans of the vehicle to obtain images of sections of the vehicle (806), e.g., by controlling the scanning system 140 of FIG. 1 to run or by the computing device itself such as the portable computing device 120 of FIG. 1 as described above. The computing device processes the obtained images to generate a damage assessment report (808), e.g., as described with respect to FIGS. 2-4, 5A-5B and/or 6. The damage assessment report can include one or more tables, e.g., table 700 of FIG. 7A or table 750 of FIG. 5B. Optionally, the computing device can store the damage assessment report together with hail damage data (e.g., scanned images and/or processed images, dent count data, and/or panel data) in the database. Optionally, the computing device can determine that there is no fraud event for the hail damage on the vehicle.

If the historical data of the vehicle is available in the database, the computing device also proceeds to perform with regular scans of the vehicle to obtain images of sections of the vehicle (810), e.g., by controlling the scanning system 140 of FIG. 1 to run or by the computing device itself such as the portable computing device 120 of FIG. 1 as described above. In some embodiments, the computing device (e.g., the computing device 108 of FIG. 1 or the portable computing device 120 of FIG. 1) processes the obtained images of sections of the vehicle to generate hail damage data, which can include processed images, dent count data, and/or panel data, e.g., as described with respect to FIGS. 2-4, 5A-5B and/or 6. For example, the hail damage data can include a respective dent count for each panel of the vehicle, a total dent count on the panels of the vehicle, and/or a respective dent count for each category type (e.g., small, medium, or large) per panel or per section or per vehicle. The hail damage data can also include processed damages, e.g., pre-processed images after removing noises or damage signatures other than hail damages like image 202 of FIG. 2, 302 of FIG. 3, or 406 of FIG. 4, processed images with detected dents like image 206 of FIG. 2, or processed image with identified panels like image 306 of FIG. 3. In some embodiments, the computing device transmits the obtained images or pre-processed images to another computing device (e.g., in the service computing system 110 of FIG. 1) for image processing to generate the hail damage data of the vehicle.

The hail damage data of the vehicle can be used by a computing device (e.g., the computing device 108 of FIG. 1, the portable computing device 120 of FIG. 1, or a computing device in the service computing system 110 of FIG. 1) to determine whether there is a fraud event for hail damage on the vehicle. The computing device can compare the present hail damage data of the vehicle to historical hail damage data of the vehicle (e.g., obtained from the database) to generate a comparison result, and determine whether a similarity between the present damage data and the historical damage data is greater than a predetermined threshold based on the comparison result. The computing device can use one or more mechanisms or workflows, including checking dent counts (e.g., as illustrated by steps 812, 813), tracking hail Strom and particle trajectory (e.g., as illustrated by steps 814, 815 and FIG. 8B), and/or matching hail density patterns within refined grids (e.g., as illustrated by steps 816, 817 and FIG. 8C). The one or more workflows can be performed in parallel and/or in any suitable order. If a flag notification is received from any one of the one or more workflows, the user can be notified by the computing device; and depending on requirements from users, logic around a manual review can be modified (820).

The computing device can set a fraud detection flag for the present damage data of at least one section of the vehicle. For example, the computing device can set a flag value to “1” representing that there is a fraud event, and “0” representing that there is no fraud event. The computing device can also associate and store, e.g., in the database, the fraud detection flag with the at least one section of the vehicle and/or the vehicle insurance claim and/or the customer associated with the vehicle. The computing device can also generate a notification (e.g., a popup window on the screen of the computing device, or a visual or audio alert or alarm signal) indicating the fraud event for the present damage data of the at least one section of the vehicle, such that the user can be notified or alerted to perform a manual review.

### Checking Dent Counts

In some embodiments, the computing device proceeds to check similar dent counts from prior records (812). The computing device can check if a number of dents (N) for each panel of the vehicle in a new scan is in a proximity of a number of dents (M) for each panel of the vehicle in a historical scan and raise flag for review if the numbers are close enough within a predefined tolerance threshold (813). N and M are integer greater than or identical to 1.

In some embodiments, for each panel of the vehicle, the computing device determines whether a ratio R indicating a difference between the number of dents N on the panel in the new scan and the number of dents M on the panel in the historical scan is smaller than the predefined tolerance threshold (e.g., 10%). In some examples, the ratio R can be defined as absolute difference abs(N−M) over N, e.g., R=abs(N−M)/N. For example, N is identical to 200, and M is identical to 195, then R is identical to 2.5%, which is smaller than the predefined tolerance threshold 10%. Thus, the computing device may raise flag for manual review. The ratio R can be also defined in any suitable way. For example, R can be defined as abs(N−M)/M, instead.

If the ratio for at least one panel of the vehicle is smaller than the predefined tolerance threshold, the computing device raises a flag for manual review. If the ratio for a panel of the vehicle is no smaller than (greater than or identical to) the predefined tolerance threshold, the computing device may continue to check another panel of the vehicle or use any other mechanism, e.g., checking hail Strom and particle trajectory tracking, and/or checking hail density pattern matching within refined grids.

In some embodiments, e.g., as discussed above, for each panel of the vehicle, the computing device classifies identified hail dents on the panel according to a plurality of category types (e.g., small, medium, large as illustrated in FIG. 7A or dots, circles, or rectangles as illustrated in FIG. 7B). In some cases, for each of the one or more panels and for each of the one or more category types, the computing device determines whether a ratio indicating a difference between a present number of identified hail damage areas with the category type and a historical number of identified hail damage areas with the category type is smaller than a predetermined threshold. In some cases, for each of the one or more panels, the computing device determines an average value of ratios for multiple category types is smaller than a predetermined threshold. In either case, the computing device can raise a flag or generate a notification if the ratio or the average value of the ratios is smaller than the predetermined threshold.

### Tracking Hail Strom and Particle Trajectory

In some embodiments, after obtaining an image of at least one section of the vehicle from the scan performed at step 810, the computing device proceeds to perform hail Strom and particle trajectory tracking (814). Hail Strom can be referred to as hail stream caused by hail storm. Particle trajectory can include hail-storm streams of particles. The image can be a processed image that includes identified damage areas (e.g., hail dents) on the at least one section of the vehicle, e.g., the image 206 as illustrated in FIG. 2. The computing device can generate present flow trajectories around the identified damage areas using one or more physics-based techniques, compare or compute image similarity scores between historical flow trajectories of damage areas on the at least one section of the vehicle and the present flow trajectories, and raise flag for review if average similarity scores are high (815).

FIG. 8B shows an example fraud detection 830 with hail Strom and particle trajectory tracking. First, an image 832 of at least one section of a vehicle is obtained. The at least one section of the vehicle can include at least one panel of the vehicle (e.g., a front panel). The image 832 can be obtained using a machine learning model that is trained to detect hail dents on the section of the vehicle, e.g., as illustrated in FIG. 2. The machine learning model can include at least one of: You Only Look Once (YOLO), single-shot detector (SSD), Faster Region-based Convolutional Neural Network (Faster R-CNN), or a computer vision algorithm. The image 832 can be, for example, the image 206 as illustrated in FIG. 2.

Second, a plurality of sub-regions 838 of a region of interest (ROI) of the image is obtained, e.g., using a sliding window technique. As shown in FIG. 8B, in the at least one section of the vehicle, e.g., a front panel, the ROI can be defined as an area in a bounding box 836. A sliding window 834 can be moved in the bounding box 836 to sequentially extract cropped sub-regions 838 of the ROI of the image. The sliding window 834 can be moved along horizontal and/or vertical directions to ensure a full coverage of the ROI. In some cases, there is an overlap between adjacent sub-regions among the plurality of sub-regions 838. In some cases, one or more parameters of the sliding window 834 (e.g., size, shape, width/length/angle) can be dynamically updated based on a dimension of the ROI (e.g., the dimension of the bounding box 836). For example, different panels have different sizes, and a sliding window for ROI of a first panel can be different from a sliding window for ROI of a second panel.

Third, for each sub-region 838 of the image, a flow trajectory image (e.g., new images 842, 844) of the sub-region can be generated, where the flow trajectory image represents flow trajectories around one or more hail damage areas (e.g., hail dents) on the sub-region of the image of the at least one section of the vehicle. The flow trajectory image can be generated using at least one particle flow simulation algorithm to approximate a flow field around each of the one or more hail damage areas on the sub-region. The at least one particle flow simulation algorithm can include a particle image velocimetry (PIV) algorithm or a combination of two or more flow simulation algorithms. The computing device can repeat the generation process to obtain a plurality of flow trajectory images for the plurality of sub-regions 838.

Fourth, for each sub-region 838 of the image, the computing device determines a similarity score for the sub-region by comparing the present flow trajectory image (e.g., the new image 842, 844) of the sub-region of the image of the at least one section of the vehicle with a historical flow trajectory image (e.g., historical image 843, 845) of a corresponding sub-region of a historical image of the at least one section of the vehicle to obtain a similarity score for the sub-region.

In some embodiments, the database stores the historical image of the at least one section of the vehicle, e.g., during a historical scan for the at least one section of the vehicle. In some embodiments, the database can also store a plurality of sub-regions of the historical image, e.g., using the same sliding window technique as the new scan, such that each sub-region in the new scan can correspond to a corresponding sub-region in the historical scan, e.g., the sub-regions in the new scan and the historical scan represent a same area in the at least one section of the vehicle. In some embodiments, the database can also store historical flow trajectory image (e.g., the historical image 843, 845) for each sub-region, e.g., by computing/calculating using the same particle flow simulation algorithm for the new sub-region.

In some embodiments, for each sub-region 838 of the image, the computing device accesses the database to retrieve the historical flow trajectory image of the corresponding sub-region of the historical image of the at least one section of the vehicle and use the retrieved historical flow trajectory image for determining the similarity score. In some embodiments, the computing device accesses the database to retrieve the corresponding sub-regions of the historical image of the at least one section of the vehicle and compute/calculate the historical flow trajectory image using the same particle flow simulation algorithm for the new sub-region, e.g., while computing the new flow trajectory image for the new sub-region 838 or after computing the plurality of new flow trajectory images for the plurality of new sub-regions 838. In some embodiments, the computing device accesses the database to retrieve the historical image of the at least one section of the vehicle. The computing device can calibrate the historical image and the new image of the at least one section of the vehicle so that a ROI in the historical image represents a same area on the at least one section of the vehicle as the ROI 836 in the new image 832. The computing device can then use the same sliding window technique on the historical image to obtain historical sub-regions corresponding to the sub-regions 838 of the new image, and compute/calculate the historical flow trajectory images of the historical sub-regions using the same particle flow simulation algorithm for the new sub-region, e.g., while computing the new flow trajectory image for the new sub-region 838 or after computing the plurality of new flow trajectory images for the plurality of new sub-regions 838.

The computing device can compute the similarity score between the present flow trajectory image and the historical flow trajectory image using one or more image similarity algorithms, e.g., Fréchet Inception Distance (FID), Mean Squared Error (MSE), and Structural Similarity Indices (SSIM), and Cosine Similarity.

For example, the MSE can be computed as the following:

$$M S E = \frac{1}{m n} {Σ}_{i = 0}^{m - 1} {{Σ}_{j = 0}^{n - 1} [ I ( i , j ) - K ( i , j ) ]}^{2} ,$$

where I and K represent images being compared, m represents the numbers of rows of pixels of the images and i represents the index of that row, and n represents the number of columns of pixels of the image and j represents the index of that column.

For example, the SSIM can be computed as the following:

$$S S I M ( x , y ) = \frac{( 2 {μ}_{x} {μ}_{y} + {c}_{1} ) ( 2 {σ}_{x y} + {c}_{2} )}{( {μ}_{x}^{2} + {μ}_{y}^{2} + {c}_{1} ) ( {σ}_{x}^{2} + {σ}_{y}^{2} + {c}_{2} )} ,$$

where μₓ and μ_{y} are the local means, σₓ and σ_{y} are the standard deviations and Oxy is the cross-covariance for images x and y respectively.

For example, the cosine similarity can be computed as the following:

$$cos ( θ ) = \frac{A \cdot B}{‖ A ‖ ‖ B ‖} = \frac{{Σ}_{i = 1}^{n} {A}_{i} {B}_{i}}{\sqrt{{Σ}_{i = 1}^{n} {A}_{i}^{2}} \sqrt{{Σ}_{i = 1}^{n} {B}_{i}^{2}}} ,$$

where A and B are the images being compared.

For example, the Fréchet inception distance (FID) can be used to assess the quality of images created by a generative model, e.g., a generative adversarial network (GAN). Unlike the earlier inception score (IS), which evaluates only the distribution of generated images, the FID compares the distribution of generated images with the distribution of a set of real images (“ground truth”).

The computing device can determine a similarity between the new sub-region 838 and the corresponding historical sub-region based on the similarity score between the present flow trajectory image (e.g., the new image 842, 844) of the new sub-region 838 and the historical flow trajectory image (e.g., the historical image 843, 845) of the corresponding historical sub-region. For example, as illustrated in FIG. 8B, the new image 842 and the historical image 843 have a low similarity score. The low similarity score indicates that the new sub-region 838 has low similarity compared to the corresponding historical sub-region and further indicates that the hail dents on the new sub-region 838 have low similarity compared to the hail dents on the corresponding historical sub-region. Thus, there is a high probability that the hail dents on the new sub-region 838 can be new hail dents and there may be no fraud event. In contrast, as illustrated in FIG. 8B, the new image 844 and the historical image 845 have a high similarity score. The high similarity score indicates that the new sub-region 838 has high similarity compared to the corresponding historical sub-region and further indicates that the hail dents on the new sub-region 838 have high similarity compared to the hail dents on the corresponding historical sub-region. Thus, there is a high probability that at least some of the hail dents on the new sub-region 838 are historical hail dents and there may be a fraud event.

In some embodiments, the computing device repeats determining the similarity scores for each of the plurality of sub-regions 838 of the at least one section of the image and determining the similarity between the present damage data and the historical damage data based on an average similarity score of similarity scores for the plurality of sub-regions of the image of the at least one section of the vehicle. The computing device can compare the average similarity score with a predetermined threshold (e.g., 90%). If the average similarity score is greater than or identical to the predetermined threshold, the computing device can determine that the hail dents on the at least one section of the vehicle can be historical hail dents and there is a fraud event. In response, the computing device can raise flag for review. If the average similarity score is smaller than the predetermined threshold, the computing device can determine there is no fraud event or check a result of the other mechanisms, e.g., as shown in steps 812 and 813 and/or steps 816 and 817.

### Matching Hail Density Patterns

In some embodiments, the computing device proceeds to perform hail density pattern matching within refined grids (817). The computing device can define a refined grid on a scanned image of at least one section of the vehicle, compare/compute image similarity scores on portions of historical and new scanned images in corresponding grids, compute an average similarity score for each grid-image pairs from the new and historical scans, and raise flag for review if the average similarity score is higher than a predetermined threshold (817).

FIG. 8C shows another example fraud detection 850 with hail density pattern matching. First, a present image 852 of at least one section of a vehicle is obtained. The at least one section of the vehicle can include at least one panel of the vehicle (e.g., a front panel). The present image 852 can be obtained using a machine learning model that is trained to detect hail dents on the section of the vehicle, e.g., as illustrated in FIG. 2. The machine learning model can include at least one of: You Only Look Once (YOLO), single-shot detector (SSD), Faster Region-based Convolutional Neural Network (Faster R-CNN), or a computer vision algorithm. The present image 852 can be the same as the image 832 of FIG. 8B or the image 206 of FIG. 2. As illustrated in FIG. 8C, the present image 852 can include identified hail dents 858, each of which is enclosed by a corresponding bounding box.

Second, the computing device defines a refined grid 854 on the present image 852 to obtain a plurality of present portions 856 of the present image 852 of the at least one section of the vehicle. Different from the sliding window technique where there is an overlap between adjacent sub-regions 838 of FIG. 8B, there is no overlap between adjacent portions 856 of the present image 852 obtained by the refined grid 854.

Third, for each present portion 856, the computing device determines a similarity score for the present portion by comparing the present portion of the present image 852 of the at least one section of the vehicle with a corresponding historical portion of a historical image of the at least one section of the vehicle.

In some embodiments, the database stores the historical image of the at least one section of the vehicle, e.g., during a historical scan for the at least one section of the vehicle. In some embodiments, the database can also store a plurality of historical portions of the historical image, e.g., using the same refined grid 854 for the new image, such that each present portion in the present image can correspond to a corresponding historical portion in the historical image, e.g., the present portion in the present image and the corresponding historical portion in the historical image represent a same area in the at least one section of the vehicle.

In some embodiments, the computing device accesses the database to retrieve the corresponding portions of the historical image of the at least one section of the vehicle and uses the retrieved portions of the historical image for determining the similarity score. In some embodiments, the computing device accesses the database to retrieve the historical image of the at least one section of the vehicle. The computing device can calibrate the historical image and the new image of the at least one section of the vehicle so that a refined grid covers the same area on the at least one section of the vehicle. The computing device can then use the same refined grid on the historical image to obtain historical portions corresponding to the portions of the new image for determining the similarity score.

Similar to computing the similarity score for flow trajectory images, the computing device can compute the similarity score between the present portion (e.g., new image 862, 864) of the image and the corresponding portion (e.g., historical image 863, 865) of the historical image using one or more image similarity algorithms, e.g., Fréchet Inception Distance (FID), Mean Squared Error (MSE), and Structural Similarity Indices (SSIM), and Cosine Similarity.

The computing device can determine a similarity between the present portion of the present image of the at least one section of the vehicle and the corresponding historical portion of the historical image of the at least one section of the vehicle based on the similarity score between the present portion (e.g., the new image 862, 864) and the historical portion (e.g., the historical image 863, 865). For example, as illustrated in FIG. 8C, the new image 862 and the historical image 863 have a high similarity score. The high similarity score indicates that the new image 862 has high similarity compared to the corresponding historical image 863 and further indicates that hail dents on the present portion have high similarity compared to the hail dents on the corresponding historical portion. Thus, there is a high probability that at least some of the hail dents on the new portion are historical hail dents and there may be a fraud event. In contrast, the new image 864 and the historical image 865 have a low similarity score. The low similarity score indicates that the present portion has low similarity compared to the corresponding historical portion and further indicates that the hail dents on the present portion has low similarity compared to the hail dents on the corresponding historical portion. Thus, there is a high probability that the hail dents on the present portion can be new hail dents and there may be no fraud event.

In some embodiments, the computing device repeats determining the similarity scores for each of the plurality of portions 856 of the at least one section of the present image 852 and determining the similarity between the present damage data and the historical damage data based on an average similarity score of similarity scores for the plurality of portions 856 of the present image 852 of the at least one section of the vehicle. The computing device can compare the average similarity score with a predetermined threshold (e.g., 90%). If the average similarity score is greater than or identical to the predetermined threshold, the computing device can determine that the hail dents on the at least one section of the vehicle can be historical hail dents and there is a fraud event. In response, the computing device can raise flag for review. If the average similarity score is smaller than the predetermined threshold, the computing device can determine there is no fraud event or check a result of the other mechanisms, e.g., as shown in steps 812 and 813 and/or steps 814 and 815.

### Example Dent Count Adjustment

To assess hail damage on a vehicle, at least one computing device can determine each dent count for each panel of the vehicle, e.g., as illustrated in FIGS. 7A and 7B. As noted above, the at least one computing device can include, e.g., the computing device 108 of FIG. 1, the portable computing device 120 of FIG. 1, and/or a computing device in the service computing system 110 of FIG. 1. In some embodiments, an application running on the computing device can be configured to fine-tune a total dent count of hail dents on the vehicles or individual dent counts for the panels of the vehicles. In some cases, the application is a standalone application running on the computing device. In some cases, the application is an integrated application that can be also configured to perform other functions, e.g., perform fraud detection according to the process 800 as illustrated in FIGS. 8A-8C. The application can also be configured to perform image processing, e.g., identifying damage areas (e.g., hail dents) and/or identifying individual panels of the vehicle, as discussed above.

FIG. 9 is a screen shot of an example graphical user interface (GUI) 900 of the application for assessing damages on a vehicle. The GUI 900 can show information 901 of a user (e.g., an operator), a scanned result 902 of the vehicle showing identified panels with corresponding identified damage areas (e.g., hail dents) 904, a total dent count 906 for all the panels, and/or dent counts 908 for individual panels. The panels can include left fender, left rail, left front door, left rear door, left quarter, left fuel lid, hood, and/or roof. Different panels can be presented with different corresponding colors in the scanned result 902. The identified damage areas 904 can be categorized, e.g., according to sizes of the damage areas such as dime, nickel, quarter, Half Dollar, Oversize, or Double Oversize. In some embodiments, the GUI 900 can also present the different damages areas according to the categorized result with different colors 905. The GUI 900 can also present different views 912 of the scanned result of the vehicle, e.g., top, right, left, rear. The application can receive an input of the user selecting one of the views, e.g., top, and show the scanned result 902 in the selected view.

The application can be configured to adjust the total dent count or individual dent counts for panels by using a probability threshold. The application can use the probability threshold to clean the damage data according to user preferences. The probability threshold can be fine-tuned manually, e.g., a slidable/tunable dial or slider 910 integrated in the GUI 900, or automatically, e.g., by performing a function based on historical or other customer data points.

The application can be equipped with better sensitivity adjustment features according to user preferences or variables of a particular shop and/or scan. For example, a user (e.g., a vehicle repair shop owner or operator) may want the ability or flexibility to fine-tune a total dent count, which can ensure improved model accuracies. In some examples, the dent count can be adjusted based on variables that might include: i) color of the vehicle (dents can be harder to distinguish on darker vehicles); ii) ambient lighting in shop (which changes ability to distinguish whether a dent is present or not); and/or iii) human preference for what should be considered a dent/damage.

In some embodiments, using the historical information collected over time on several car types, make, year, color, the application can be configured to recommend suitable threshold for each car. The application can utilize historical information on regions, car types, colors, and/or dent densities per panel to train a machine learning model, which tends to learn the features and corresponding probability thresholds being used. Once the machine learning model is sufficiently trained, the machine learning model can start recommending suitable thresholds to users. In some embodiments, based on customer and/or service provider's requirements, the accuracy of the predictive model can be improved by enabling the users to adjust the probability/confidence threshold for the model to detect/classify a signature on each panel as hail dents. The users can also set a custom threshold based on car type and color. Based on validation/feedback received from the users, the machine learning model can continue to learn and improve recommendations in a self-continuous learning mode.

In some embodiments, when the probability threshold is changed, the dent count/density of each panel of the vehicle is changed accordingly, which can be changed with a same ratio and/or with different ratios based on different weights for the different panels. The total dent count/density for the panels of the vehicle can be changed accordingly, e.g., based on the changes of the dent count/density of each panel.

### Example Filtering Damage Signatures

In some cases, one or more damage signatures (or features) may be similar to hail damages (e.g., dents), but not caused by hailstorms. To accurately assess hail damage and/or perform fault detection, it is desirable to filter out these damage signatures (either present and/or historical) from the hail dents. An application, e.g., the application for dent detection and/or fraud detection as discussed above, can be configured to automatically remove prior damage signatures from the detection and/or analysis to improve model sensitivity and/or accuracy.

A damage signature can include a mechanical dent or a pinch point (caused by metal deformation) at one or more locations, e.g., hail-tail light, a windshield, or a door-window interface. For example, FIGS. 10A-10B are images 1000, 1010 showing damage signatures other than hail damages. FIG. 10A shows damage signatures 1004a, 1004b that appear on a head-tail light 1002. FIG. 10B shows pinch points 1014 caused by metal deformation at a door-window interface 1012. The pinch points can be caused due to metal deformation during a mechanical forming process. These damage signatures appear like hail dents, which can cause false positives in dent detection and/or fault detection.

FIG. 10C is a flow chart of an example process 1050 for managing damage signatures on a vehicle. The process 1050 can be performed by a computing device, e.g., the computing device 108 of FIG. 1, the portable computing device 120 of FIG. 1, and/or a computing device in the service computing system 110 of FIG. 1. The process 1050 can be used to improve the accuracy and/or sensitivity of the hail dent detection and/or fault detection.

A training dataset is be generated based on isolated damages/pinch point signatures from particular locations of the vehicle (1052). For example, FIG. 10D shows an example of the training dataset 1060 for identifying damage signatures, which includes a plurality of images 1022 of the isolated damages and/or pinch point signatures from different locations.

A classification model is trained to detect and/or classify the damage/pinch point signatures (1054). The classification model can be based on artificial intelligence (AI)-machine learning (ML) and can include Efficient Net Architecture, XG-Boost, Ensemble Model, and/or a combination of multiple ML models.

The trained model is used to identify and filter out these prior damage/pinch point signatures from identified hail dents and/or from a final hail dent count (at 1056), e.g., before generating a damage assessment report, which can improve the detection accuracy. As an example, FIG. 10E shows an image 1080 including identified or detected a damage signature 1082 at a windshield and pinch points 1084, 1086 at a head-tail light of the vehicle.

### Example Processes

FIG. 11 is a flow chart of an example process 1100 for assessing damages on vehicles for fraud detection. The process 1100 can be performed by at least one computing device, e.g., the computing device 108 of FIG. 1, the portable computing device 120 of FIG. 1, and/or a computing device in the service computing system 110 of FIG. 1. The process 1100 can be performed by at least one application running on the at least one computing device. As discussed above and below, the at least one application can be configured to perform fraud detection with one or more mechanisms, including checking similar dent counts, checking hail Strom and particle trajectory tracking, and/or checking hail density pattern matching within refined grids, e.g., as discussed with details with respect to FIGS. 8A-8C.

In some embodiments, the at least one application is an integrated application that can be configured to perform one or more functions. For example, the at least one application can be also configured to fine-tune a total dent count of hail dents on the vehicles or individual dent counts for the panels of the vehicles, e.g., as illustrated with details with respect to FIG. 9. The at least one application can be also configured to perform image processing, e.g., identifying damage areas (e.g., hail dents) and/or identifying individual panels of the vehicle, e.g., as discussed with details with respect to FIGS. 2-6. The at least one application can be also configured to filter out one or more damage signatures that are not hail dents, e.g., as discussed with details with respect to FIGS. 10A to 10E.

Present damage data of at least one section of a vehicle is determined based on an image of the at least one section of the vehicle using at least one machine learning (ML) model (1102). The present damage data includes information of a plurality of hail damage areas on the at least one section of the vehicle. The present damage data of the at least one section of the vehicle is compared to historical damage data of the at least one section of the vehicle to generate a comparison result (1104). Whether there is a fraud event is determined based on the comparison result (1106).

In some embodiments, determining whether there is a fraud event based on the comparison result includes: determining whether a similarity between the present damage data and the historical damage data is greater than a predetermined threshold based on the comparison result, e.g., as illustrated in FIG. 8A.

In some cases, in response to determining that the similarity between the present damage data and the historical damage data is greater than the predetermined threshold based on the comparison result, the process 1100 can further include determining that there is a fraud event for the present damage data of the at least one section of the vehicle. The process 1100 can further include at least one of: setting a fraud detection flag for the present damage data of the at least one section of the vehicle, or generating a notification indicating the fraud event for the present damage data of the at least one section of the vehicle, e.g., as described with details with respect to step 820 of FIG. 8A.

In some cases, in response to determining that the similarity between the present damage data and the historical damage data is no greater than the predetermined threshold based on the comparison result, the process 1100 can further include: determining that there is no fraud event for the present damage data of the at least one section of the vehicle. The process 1100 can further include at least one of: generating a notification indicating there is no fraud event for the present damage data of the at least one section of the vehicle, or generating a damage assessment report based on the present damage data of the at least one section of the vehicle (e.g., as described with details with respect to step 808 of FIG. 8A).

In some embodiments, determining whether the similarity between the present damage data and the historical damage data is greater than the predetermined threshold based on the comparison result includes at least one of: determining whether a ratio indicating a difference between a present number of hail damage areas on the at least one section of the vehicle and a historical number of hail damage areas in the at least one section of the vehicle is smaller than a first threshold (e.g., as described with details with respect to steps 812, 813 of FIG. 8A), determining whether a similarity between present flow trajectories around present hail damage areas on the at least one section of the vehicle and historical flow trajectories around historical hail damage areas on the at least one section of the vehicle is greater than a second threshold (e.g., as described with details with respect to steps 814, 815 of FIG. 8A or FIG. 8B), or determining whether a similarity between one or more present image portions of the image of the at least one section of the vehicle and one or more corresponding image portions of a historical image of the at least one section of the vehicle is greater than a third threshold (e.g., as described with details with respect to steps 816, 817 of FIG. 8A or FIG. 8C).

In some embodiments, the present damage data of the at least one section of the vehicle includes a respective number of hail damage areas for each of one or more panels presented in the at least one section of the vehicle, e.g., as described with details with respect to FIG. 7A or FIG. 7B. Determining whether the similarity between the present damage data and the historical damage data is greater than the predetermined threshold based on the comparison result can include: determining whether a ratio indicating a difference between a present number of hail damage areas in one of the one or more panels and a historical number of hail damage areas in the one of the one or more panels is smaller than a predetermined threshold.

In some embodiments, the process 1100 further includes: for each of the one or more panels, classifying one or more identified hail damage areas correlated with the panel according to one or more category types for the one or more identified hail damage areas; and for each of the one or more category types, counting a respective number of identified hail damage areas that are correlated with the panel and have a same category type, e.g., as shown in the table 700 of FIG. 7A or in the table 750 of 7B. Determining whether the similarity between the present damage data and the historical damage data is greater than the predetermined threshold based on the comparison result can include at least one of: for each of the one or more panels and for each of the one or more category types, determining whether a ratio indicating a difference between a present number of identified hail damage areas with the category type and a historical number of identified hail damage areas with the category type is smaller than a second predetermined threshold, or for each of the one or more panels, determining an average of one or more ratios for the one or more category types is smaller than a third predetermined threshold.

In some embodiments, e.g., as described with details with respect to FIGS. 8A and 8B, determining whether the similarity between the present damage data and the historical damage data is greater than the predetermined threshold based on the comparison result includes: obtaining each of a plurality of sub-regions (e.g., sub-region 838 of FIG. 8B) of the image (e.g., the image 832 of FIG. 8B) of the at least one section of the vehicle; generating a present flow trajectory image (e.g., the new image 842 or 844 of FIG. 8B) of the sub-region, the present flow trajectory image representing flow trajectories around one or more hail damage areas on the sub-region of the image of the at least one section of the vehicle; determining a similarity score for the sub-region by comparing the present flow trajectory image of the sub-region of the image of the at least one section of the vehicle with a historical flow trajectory image of a corresponding sub-region (e.g., the historical image 843 or 845 of FIG. 8B) of a historical image of the at least one section of the vehicle to obtain a similarity score for the sub-region; and determining the similarity between the present damage data and the historical damage data based on the similarity score for the sub-region.

In some embodiments, determining the similarity between the present damage data and the historical damage data based on the similarity score for the sub-region includes: determining the similarity based on an average similarity score of similarity scores for the plurality of sub-regions of the image of the at least one section of the vehicle.

In some embodiments, obtaining each of the plurality of sub-regions of the image of the at least one section of the vehicle includes: moving a sliding window (e.g., the sliding window 834 of FIG. 8B) on the image to sequentially extract the plurality of sub-regions. The sliding window can be moved along horizontal and vertical directions to ensure a full coverage of a region of interest in the image of the at least one section of the vehicle. The sliding window can be dynamically updated based on a size of the at least one section of the vehicle or a region of interest (ROI) (e.g., the ROI 836 of FIG. 8B) in the at least one section of the vehicle. There can be an overlap between adjacent sub-regions among the plurality of sub-regions of the image.

In some embodiments, generating the present flow trajectory image of the sub-region includes: using at least one particle flow simulation algorithm to approximate a flow field around each of the one or more hail damage areas on the sub-region, the at least one particle flow simulation algorithm comprising a particle image velocimetry (PIV) algorithm. The similarity score for the sub-region can be determined by computing the similarity score between the present flow trajectory image and the historical flow trajectory image using one or more image similarity algorithms. The one or more image similarity algorithms can include Frechet Inception Distance (FID), Mean Squared Error (MSE), Structural Similarity Indices (SSIM), and/or cosine similarity.

In some embodiments, e.g., as discussed with details with respect to steps 816, 817 of FIG. 8A and FIG. 8C, determining whether the similarity between the present damage data and the historical damage data is greater than the predetermined threshold based on the comparison result includes: obtaining each of a plurality of portions (e.g., the portion 858 of FIG. 8C) of the image (e.g., the image 852 of FIG. 8C) of the at least one section of the vehicle; determining a similarity score for the portion by comparing the portion (e.g., the portion 862, 864 of FIG. 8C) of the image of the at least one section of the vehicle with a corresponding portion (e.g., the portion 863, 865 of FIG. 8C) of a historical image of the at least one section of the vehicle to obtain a similarity score for the portion; and determining the similarity between the present damage data and the historical damage data based on the similarity score for the portion.

In some embodiments, obtaining each of the plurality of portions of the image of the at least one section of the vehicle includes: defining a grid (e.g., the grid 854 of FIG. 8C) on the image of the at least one section of the vehicle. There is no overlap between adjacent portions of the plurality of sub-regions of the image.

In some embodiments, determining the similarity between the present damage data and the historical damage data based on the similarity score for the portion includes: determining the similarity based on an average similarity score of similarity scores for the plurality of portions of the image of the at least one section of the vehicle. Determining the similarity score for the portion can include: computing the similarity score between the portion of the image and the corresponding portion of the historical image using one or more image similarity algorithms comprising Frechet Inception Distance (FID), Mean Squared Error (MSE), Structural Similarity Indices (SSIM), and cosine similarity.

In some embodiments, the image of the at least one section of the vehicle includes a processed image with a respective bounding box enclosing each of the plurality of hail damage areas on the at least one section of the vehicle. The image can be the image 206 of FIG. 2, the image 830 of FIG. 8B, or the image 850 of FIG. 8C.

In some embodiments, determining the present damage data of the at least one section of the vehicle based on the image of the at least one section of the vehicle using the at least one machine learning (ML) model includes at least one of: identifying the plurality of hail damage areas present on the at least one section of the vehicle in the image using a first model that has been trained (e.g., as discussed with details with respect to FIG. 2, FIG. 5A, or FIG. 6); identify one or more panels of the vehicle that are present in the at least one section of the vehicle in the image using a second model that has been trained (e.g., as discussed with details with respect to FIG. 3, FIG. 5A or FIG. 6); or generating the present damage data by correlating the plurality of hail damage areas and the one or more panels to determine, for each of the one or more panels of the vehicle, one or more respective hail damage areas that are present on the panel (e.g., as discussed with details with respect to FIG. 7A or 7B).

In some embodiments, the first model includes at least one of: You Only Look Once (YOLO), single-shot detector (SSD), Faster Region-based Convolutional Neural Network (Faster R-CNN), or a computer vision algorithm. The second model can include at least one of: masked R-CNN, thresholding segmentation, edge-Based segmentation, region-based segmentation, watershed segmentation, or clustering-based segmentation.

In some embodiments, the process 1100 further includes: obtaining the image of the at least one section of the vehicle by at least one of: scanning the at least one section of the vehicle at a scanning position using a hybrid three-dimensional (3D) optical scanning system (e.g., the scanning system 140 of FIG. 1) or a camera of a mobile device (e.g., the mobile device 120 of FIG. 1), receiving the image from a remote communication device configured to capture images of the vehicle, generating the image based on at least one frame of a video stream for the at least one section of the vehicle, generating the image based on multiple sectional images of the vehicle, each of the multiple sectional images being associated with a different corresponding section of the vehicle, or processing an initial image of the at least one section of the vehicle to reduce surface glare of the vehicle in the initial image (e.g., as discussed with details with respect to FIG. 4 or 5B).

In some embodiments, the process 1100 further includes: obtaining the historical damage data of the at least one section of the vehicle from a repository based on information of the at least one section of the vehicle. The repository can be a memory of the computing device, a database external to the computing device, or a database (e.g., the database 112 of FIG. 1) in a service computing system (e.g., the service computing system 110 of FIG. 1).

In some embodiments, the process 1100 further includes: checking whether historical data of the vehicle is available in a repository based on identification information of the vehicle (e.g., as discussed with details with respect to step 802 of FIG. 8A); and if the historical data of the vehicle is available in the repository, proceeding to perform fraud detection on the image of the at least one section of the vehicle (e.g., as discussed with details with respect to steps 810 to 820 of FIG. 8A), or if there is no historical data of the vehicle in the repository, proceeding to generate a damage assessment report for the vehicle, without fraud detection for the vehicle (e.g., as discussed with details with respect to steps 806, 808 of FIG. 8A). The identification information of the vehicle can include vehicle identification number (VIN) of the vehicle.

In some embodiments, determining the present damage data of the at least one section of the vehicle based on the image of the at least one section of the vehicle includes: adjusting a number of hail damage areas on the at least one section of the vehicle. The number of hail damage areas can be adjusted based on based on one or more variables that include a color of the at least one section of the vehicle, ambient lighting when scanning the at least one section of the vehicle for the image, or a preference of an operator.

In some embodiments, e.g., as described with details with respect to FIG. 9, adjusting the number of hail damage areas on the at least one section of the vehicle includes: adjusting a probability threshold by receiving an input on a user interface element for adjusting the probability threshold in a graphical user interface (GUI) (e.g., the GUI 900 of FIG. 9).

In some embodiments, adjusting the number of hail damage areas on the at least one section of the vehicle includes: automatically adjusting a probability threshold by adjusting the probability threshold based on one or more predetermined settings. The probability threshold is determined based on the one or more predetermined settings by a machine learning model that has been trained based on historical information comprising at least one of geographical regions, vehicle types, colors, or hail damage densities per panel. In some embodiments, adjusting the number of hail damage areas on the at least one section of the vehicle further includes: presenting the probability threshold to an operator; and adjusting the probability threshold based on an input of the operator.

In some embodiments, adjusting the number of hail damage areas on the at least one section of the vehicle includes at least one of: adjusting a respective number of hail damage areas on each of one or more panels in the at least one section of the vehicle, or adjusting a total number of hail damage areas on the one or more panels in the at least one section of the vehicle.

In some embodiments, e.g., as discussed with details in FIGS. 10A-10E, determining the present damage data of the at least one section of the vehicle based on the image of the at least one section of the vehicle includes: filtering out one or more particular damage areas (e.g., damage signatures such as 1004a, 1004b of FIG. 10A, 1014 of FIG. 10B, or 1082, 1084, 1086 of FIG. 10E) on the at least one section of the vehicle, each of the one or more particular damage areas being different from a hail damage area. The one or more damage signatures can be filtered out using a machine learning model that has been trained to detect or classify damage signatures. The one or more damage signatures can include damage or pinch point signatures from one or more particular locations including a head-tail light, a windshield, and a door-window interface.

FIG. 12 is a flow chart of an example process 1200 for assessing damages on vehicles with adjusting hail damage data. The process 1200 can be performed by at least one computing device, e.g., the computing device 108 of FIG. 1, the portable computing device 120 of FIG. 1, and/or a computing device in the service computing system 110 of FIG. 1. The process 1200 can be performed by at least one application running on the at least one computing device. As discussed above and below, the at least one application can be configured to adjust hail damage data such as tuning hail dent counts, e.g., as discussed with details with respect to FIG. 9.

In some embodiments, the at least one application is an integrated application that can be configured to perform one or more functions. For example, the at least one application can be also configured to perform fraud detection with one or more mechanisms, e.g., as discussed with details with respect to FIGS. 8A-8C and FIG. 11. The at least one application can be also configured to perform image processing, e.g., identifying damage areas (e.g., hail dents) and/or identifying individual panels of the vehicle, e.g., as discussed with details with respect to FIGS. 2-6. The at least one application can be also configured to filter out one or more damage signatures that are not hail dents, e.g., as discussed with details with respect to FIGS. 10A to 10E.

An image of at least one section of a vehicle is obtained (1202). The image can be the input image 202 of FIG. 2, the input image 302 of FIG. 3, or the input image 404 of FIG. 4. Hail damage data of the at least one section of the vehicle is determined based on the image of the at least one section of the vehicle using at least one machine learning (ML) model (1204). The hail damage data includes information of hail damage areas on the at least one section of the vehicle, e.g., hail dent counts per panel according to different categories such as sizes or shapes. The hail damage data of the at least one section of the vehicle is adjusted by adjusting a number of the hail damage areas on the at least one section of the vehicle (1206). An output about hail damage assessment information of the at least one section of the vehicle is generated based on the adjusted hail damage data (1208).

In some embodiments, the process 1200 further includes: determining whether there is a fraud event based on the adjusted hail damage data, e.g., as discussed with details with respect to FIGS. 8A-8C and FIG. 11. If the application determines that there is a fraud event for the adjusted hail damage data, the application raises flag for review, e.g., as discussed in FIG. 8A. If the application there is no fraud event for the adjusted hail damage data, a damage assessment report can be generated based on the adjusted hail damage data.

In some embodiments, adjusting the hail damage data of the at least one section of the vehicle includes: adjusting the hail damage data of the at least one section of the vehicle based on one or more variables. The one or more variables can include a color of the at least one section of the vehicle, ambient lighting when scanning the at least one section of the vehicle for the image, or a preference of an operator.

In some embodiments, adjusting the number of the hail damage areas on the at least one section of the vehicle includes: adjusting a probability threshold by receiving an input on a user interface element for adjusting the probability threshold in a graphical user interface (GUI) (e.g., the GUI 900 of FIG. 9). The process 1200 can further include: presenting, in the GUI, the user interface element as an adjustable slider (e.g., the slider 910 of FIG. 9), an image (e.g., the image 902 of FIG. 9) of the vehicle showing a plurality of panels of the vehicle in different colors, and names of the plurality of panels with corresponding numbers of hail damage areas on the plurality of panels, e.g., as illustrated in FIG. 9. The corresponding number of hail damage areas on the plurality of panels can be changeable with the probability threshold by the adjustable slider.

In some embodiments, adjusting the number of the hail damage areas on the at least one section of the vehicle includes: automatically adjusting a probability threshold by adjusting the probability threshold based on one or more predetermined settings. The probability threshold can be determined based on the one or more predetermined settings by a machine learning model that has been trained based on historical information comprising at least one of geographical regions, vehicle types, colors, or hail damage densities per panel. In some cases, the probability threshold determined or predicted by the machine learning model can be presented to an operator, and the application can adjust the probability threshold based on the input of the operator.

In some embodiments, adjusting the number of the hail damage areas on the at least one section of the vehicle includes: adjusting a respective number of hail damage areas on each of one or more panels in the at least one section of the vehicle, or adjusting a total number of hail damage areas on the one or more panels in the at least one section of the vehicle.

In some embodiments, determining the hail damage data of the at least one section of the vehicle based on the image of the at least one section of the vehicle includes: filtering out one or more damage signatures on the at least one section of the vehicle, each of the one or more damage signatures (e.g., 1004a, 1004b of FIG. 10A, 1014 of FIG. 10B, 1082, 1084, or 1086 of FIG. 10E) being different from a hail damage area, e.g., by using a machine learning model that has been trained to detect or classify damage signatures. The one or more damage signatures can include one or more damage or pinch point signatures caused by metal deformation at one or more particular locations, e.g., a head-tail light, a windshield, or a door-window interface.

In some embodiments, determining the present damage data of the at least one section of the vehicle based on the image of the at least one section of the vehicle using the at least one machine learning (ML) model includes at least one of: identifying the plurality of hail damage areas present on the at least one section of the vehicle in the image using a first model that has been trained (e.g., as discussed with details with respect to FIG. 2, FIG. 5A, or FIG. 6); identify one or more panels of the vehicle that are present in the at least one section of the vehicle in the image using a second model that has been trained (e.g., as discussed with details with respect to FIG. 3, FIG. 5A or FIG. 6); or generating the present damage data by correlating the plurality of hail damage areas and the one or more panels to determine, for each of the one or more panels of the vehicle, one or more respective hail damage areas that are present on the panel (e.g., as discussed with details with respect to FIG. 7A or 7B).

In some embodiments, the first model includes at least one of: You Only Look Once (YOLO), single-shot detector (SSD), Faster Region-based Convolutional Neural Network (Faster R-CNN), or a computer vision algorithm. The second model can include at least one of: masked R-CNN, thresholding segmentation, edge-Based segmentation, region-based segmentation, watershed segmentation, or clustering-based segmentation.

FIG. 13 is a flow chart of an example process 1300 for assessing damages on vehicles with filtering out damage signatures. The process 1300 can be performed by at least one computing device, e.g., the computing device 108 of FIG. 1, the portable computing device 120 of FIG. 1, and/or a computing device in the service computing system 110 of FIG. 1. The process 1100 can be performed by at least one application running on the at least one computing device. As discussed above and below, the at least one application can be also configured to filter out one or more damage signatures that are not hail dents, e.g., as discussed with details with respect to FIGS. 10A to 10E.

In some embodiments, the at least one application is an integrated application that can be configured to perform one or more functions. For example, the at least one application can be configured to perform fraud detection with one or more mechanisms, e.g., as discussed with details with respect to FIGS. 8A-8C or FIG. 11. The at least one application can be also configured to fine-tune a total dent count of hail dents on the vehicles or individual dent counts for the panels of the vehicles, e.g., as illustrated with details with respect to FIG. 9 or 12. The at least one application can be also configured to perform image processing, e.g., identifying damage areas (e.g., hail dents) and/or identifying individual panels of the vehicle, e.g., as discussed with details with respect to FIGS. 2-6.

An image of at least one section of a vehicle is obtained (1302). The image can be the input image 202 of FIG. 2, the input image 302 of FIG. 3, or the input image 404 of FIG. 4. Hail damage data of the at least one section of the vehicle is determined based on the image of the at least one section of the vehicle using at least one machine learning (ML) model (1304). The hail damage data includes information of hail damage areas on the at least one section of the vehicle, e.g., hail dent counts per panel according to different categories such as sizes or shapes. The hail damage data can be determined by filtering out one or more damage signatures on the at least one section of the vehicle, and each of the one or more damage signatures is different from a hail damage area. An output about hail damage assessment information of the at least one section of the vehicle is generated based on the determined hail damage data (1306).

In some embodiments, the one or more damage signatures include one or more damage or pinch point signatures caused by metal deformation at one or more particular locations such as a head-tail light, a windshield, or a door-window interface e.g., the damage signature 1004a, 1004b of FIG. 10A, 1014 of FIG. 10B, 1082, 1084, or 1086 of FIG. 10E.

In some embodiments, filtering out the one or more damage signatures on the at least one section of the vehicle can be performed using a machine learning model that has been trained to detect or classify damage signatures.

In some embodiments, the process 1300 further includes: determining whether there is a fraud event based on the hail damage data, e.g., as described with details with respect to FIGS. 8A-8C or FIG. 11. If there is a fraud event, the process 1300 can include: setting a fraud detection flag or generating a notification indicating the fraud event. If there is no fraud event, the process 1300 can proceed to generate a damage assessment report based on the hail damage data.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system can encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices, magnetic disks. The processor and the memory can be supplemented by, or incorporated in, special purpose logic circuitry.

While this document can describe many specifics, these should not be construed as limitations on the scope of an invention that is claimed or of what can be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination in some cases can be excised from the combination, and the claimed combination can be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A computer-implemented method comprising:
determining present damage data of at least one section of a vehicle based on an image of the at least one section of the vehicle using at least one machine learning (ML) model, the present damage data comprising information of a plurality of hail damage areas on the at least one section of the vehicle;
comparing the present damage data of the at least one section of the vehicle to historical damage data of the at least one section of the vehicle to generate a comparison result; and
determining whether there is a fraud event based on the comparison result.

2. The computer-implemented method of claim 1, wherein determining whether there is a fraud event based on the comparison result comprises:
determining whether a similarity between the present damage data and the historical damage data is greater than a predetermined threshold based on the comparison result.

3. The computer-implemented method of claim 2, further comprising:
in response to determining that the similarity between the present damage data and the historical damage data is greater than the predetermined threshold based on the comparison result, determining that there is a fraud event for the present damage data of the at least one section of the vehicle, and
setting a fraud detection flag for the present damage data of the at least one section of the vehicle, or generating a notification indicating the fraud event for the present damage data of the at least one section of the vehicle.

4. The computer-implemented method of claim 2, further comprising:
in response to determining that the similarity between the present damage data and the historical damage data is no greater than the predetermined threshold based on the comparison result, determining that there is no fraud event for the present damage data of the at least one section of the vehicle, and
generating a notification indicating there is no fraud event for the present damage data of the at least one section of the vehicle, or generating a damage assessment report based on the present damage data of the at least one section of the vehicle.

5. The computer-implemented method of claim 2, wherein determining whether the similarity between the present damage data and the historical damage data is greater than the predetermined threshold based on the comparison result comprises at least one of:
determining whether a ratio indicating a difference between a present number of hail damage areas on the at least one section of the vehicle and a historical number of hail damage areas in the at least one section of the vehicle is smaller than a first threshold,
determining whether a similarity between present flow trajectories around present hail damage areas on the at least one section of the vehicle and historical flow trajectories around historical hail damage areas on the at least one section of the vehicle is greater than a second threshold, or
determining whether a similarity between one or more present image portions of the image of the at least one section of the vehicle and one or more corresponding image portions of a historical image of the at least one section of the vehicle is greater than a third threshold.

6. The computer-implemented method of claim 2, wherein the present damage data of the at least one section of the vehicle comprises a respective number of hail damage areas for each of one or more panels presented in the at least one section of the vehicle, and
wherein determining whether the similarity between the present damage data and the historical damage data is greater than the predetermined threshold based on the comparison result comprises:
determining whether a ratio indicating a difference between a present number of hail damage areas in one of the one or more panels and a historical number of hail damage areas in the one of the one or more panels is smaller than a predetermined threshold.

7. The computer-implemented method of claim 6, further comprising:
for each of the one or more panels,
classifying one or more identified hail damage areas correlated with the panel according to one or more category types for the one or more identified hail damage areas; and
for each of the one or more category types, counting a respective number of identified hail damage areas that are correlated with the panel and have a same category type,
wherein determining whether the similarity between the present damage data and the historical damage data is greater than the predetermined threshold based on the comparison result comprises at least one of:
for each of the one or more panels and for each of the one or more category types, determining whether a ratio indicating a difference between a present number of identified hail damage areas with the category type and a historical number of identified hail damage areas with the category type is smaller than a second predetermined threshold, or
for each of the one or more panels, determining an average of one or more ratios for the one or more category types is smaller than a third predetermined threshold.

8. The computer-implemented method of claim 2, wherein determining whether the similarity between the present damage data and the historical damage data is greater than the predetermined threshold based on the comparison result comprises:
obtaining each of a plurality of sub-regions of the image of the at least one section of the vehicle;
generating a present flow trajectory image of the sub-region, the present flow trajectory image representing flow trajectories around one or more hail damage areas on the sub-region of the image of the at least one section of the vehicle;
determining a similarity score for the sub-region by comparing the present flow trajectory image of the sub-region of the image of the at least one section of the vehicle with a historical flow trajectory image of a corresponding sub-region of a historical image of the at least one section of the vehicle to obtain a similarity score for the sub-region; and
determining the similarity between the present damage data and the historical damage data based on the similarity score for the sub-region.

9. The computer-implemented method of claim 8, wherein obtaining each of the plurality of sub-regions of the image of the at least one section of the vehicle comprises:
moving a sliding window on the image to sequentially extract the plurality of sub-regions.

10. The computer-implemented method of claim 8, wherein there is an overlap between adjacent sub-regions among the plurality of sub-regions of the image.

11. The computer-implemented method of claim 8, wherein generating the present flow trajectory image of the sub-region comprises:
using at least one particle flow simulation algorithm to approximate a flow field around each of the one or more hail damage areas on the sub-region, the at least one particle flow simulation algorithm comprising a particle image velocimetry (PIV) algorithm.

12. The computer-implemented method of claim 8, wherein determining the similarity score for the sub-region comprises:
computing the similarity score between the present flow trajectory image and the historical flow trajectory image using one or more image similarity algorithms comprising Frechet Inception Distance (FID), Mean Squared Error (MSE), and Structural Similarity Indices (SSIM), and Cosine Similarity.

13. The computer-implemented method of claim 2, wherein determining whether the similarity between the present damage data and the historical damage data is greater than the predetermined threshold based on the comparison result comprises:
obtaining a plurality of portions of the image of the at least one section of the vehicle;
for each portion of the plurality of portions, comparing the portion of the image of the at least one section of the vehicle with a corresponding portion of a historical image of the at least one section of the vehicle to obtain a similarity score for the portion; and
determining the similarity between the present damage data and the historical damage data based on the similarity score for each portion of the plurality of portions.

14. The computer-implemented method of claim 13, wherein obtaining each of the plurality of portions of the image of the at least one section of the vehicle comprises:
defining a grid on the image of the at least one section of the vehicle,
wherein there is no overlap between adjacent portions of the plurality of portions of the image.

15. The computer-implemented method of claim 13, wherein the image of the at least one section of the vehicle comprises a processed image with a respective bounding box enclosing each of the plurality of hail damage areas on the at least one section of the vehicle.

16. The computer-implemented method of claim 1, wherein determining the present damage data of the at least one section of the vehicle based on the image of the at least one section of the vehicle using the at least one machine learning (ML) model comprises at least one of:
identifying the plurality of hail damage areas present on the at least one section of the vehicle in the image using a first model that has been trained;
identify one or more panels of the vehicle that are present in the at least one section of the vehicle in the image using a second model that has been trained; or
generating the present damage data by correlating the plurality of hail damage areas and the one or more panels to determine, for each of the one or more panels of the vehicle, one or more respective hail damage areas that are present on the panel.

17. The computer-implemented method of claim 1, further comprising:
obtaining the image of the at least one section of the vehicle by at least one of:
scanning the at least one section of the vehicle at a scanning position using a hybrid three-dimensional (3D) optical scanning system or a camera of a mobile device,
receiving the image from a remote communication device configured to capture images of the vehicle,
generating the image based on at least one frame of a video stream for the at least one section of the vehicle,
generating the image based on multiple sectional images of the vehicle, each of the multiple sectional images being associated with a different corresponding section of the vehicle, or
processing an initial image of the at least one section of the vehicle to reduce surface glare of the vehicle in the initial image.

18. The computer-implemented method of claim 1, further comprising:
obtaining the historical damage data of the at least one section of the vehicle from a repository based on information of the at least one section of the vehicle.

19. The computer-implemented method of claim 1, further comprising:
checking whether historical data of the vehicle is available in a repository based on identification information of the vehicle; and
if the historical data of the vehicle is available in the repository, proceeding to perform fraud detection on the image of the at least one section of the vehicle, or
if there is no historical data of the vehicle in the repository, proceeding to generate a damage assessment report for the vehicle, without fraud detection for the vehicle.

20. The computer-implemented method of claim 1, wherein determining the present damage data of the at least one section of the vehicle based on the image of the at least one section of the vehicle comprises:
adjusting a number of hail damage areas on the at least one section of the vehicle,
wherein adjusting the number of hail damage areas on the at least one section of the vehicle comprises at least one of:
adjusting a respective number of hail damage areas on each of one or more panels in the at least one section of the vehicle,
adjusting a total number of hail damage areas on the one or more panels in the at least one section of the vehicle,
adjusting the number of hail damage areas on the at least one section of the vehicle based on one or more variables that comprise a color of the at least one section of the vehicle, ambient lighting when scanning the at least one section of the vehicle for the image, or a preference of an operator,
adjusting a probability threshold by receiving an input on a user interface element for adjusting the probability threshold in a graphical user interface (GUI), or
automatically adjusting a probability threshold by adjusting the probability threshold based on one or more predetermined settings, wherein the probability threshold is determined based on the one or more predetermined settings by a machine learning model that has been trained based on historical information comprising at least one of geographical regions, vehicle types, colors, or hail damage densities per panel.

21. The computer-implemented method of claim 1, wherein determining the present damage data of the at least one section of the vehicle based on the image of the at least one section of the vehicle comprises:
filtering out one or more particular damage areas on the at least one section of the vehicle using a machine learning model that has been trained to detect or classify particular damage areas, each of the one or more particular damage areas being different from a hail damage area.

22. An apparatus comprising:
at least one processor; and
one or more memories coupled to the at least one processor and storing
programming instructions for execution by the at least one processor to perform operations comprising:
determining present damage data of at least one section of a vehicle based on an image of the at least one section of the vehicle using at least one machine learning (ML) model, the present damage data comprising information of a plurality of hail damage areas on the at least one section of the vehicle;
comparing the present damage data of the at least one section of the vehicle to historical damage data of the at least one section of the vehicle to generate a comparison result; and
determining whether there is a fraud event based on the comparison result.

23. A non-transitory computer readable storage medium coupled to at least one processor and having machine-executable instructions for execution by the at least one processor to perform operations comprising:
determining present damage data of at least one section of a vehicle based on an image of the at least one section of the vehicle using at least one machine learning (ML) model, the present damage data comprising information of a plurality of hail damage areas on the at least one section of the vehicle;
comparing the present damage data of the at least one section of the vehicle to historical damage data of the at least one section of the vehicle to generate a comparison result; and
determining whether there is a fraud event based on the comparison result.
